(19) United States
(12) Patent Application Publication
(10) Pub. No.: US 2015/0250194 A1
(43) Pub. Date: Sep. 10, 2015

(54) Antimicrobial Compositions for Meat Products

(71) Applicant: Kemin Industries, Inc., Des Moines, IA (US)

(72) Inventors: William Schroeder, Ames, IA (US); Robert Stomp, Clive, IA (US); Mani Badvela, West Des Moines, IA (US); Mindy Vanlaningham, Bondurant, IA (US)

(21) Appl. No.: 14/640,699

(22) Filed: Mar. 6, 2015

Related U.S. Application Data
(60) Provisional application No. 61/949,055, filed on Mar. 6, 2014.

(51) Int. Cl. A23B 4/12; A01N 59/00; A01N 37/02

(52) U.S. Cl. CPC A23B 4/12; A01N 37/02; A01N 59/00; A23V 2002/00

(57) ABSTRACT

A vinegar based-antimicrobial was developed for controlling food pathogens in meat products. The antimicrobial is prepared using liquid blending (buffering process), dehydration and standardization. The buffering process refers to partial neutralization of white distilled vinegar (300 grain) with mild bases to produce a solution containing acetic acid and its salt. The dehydration step involved the removal of water from the buffered vinegar using a dryer. The standardization step involved a plating (spraying) process wherein white distilled vinegar (300 grain) was applied to the dried, buffered vinegar to meet the target active component as well as other physical and chemical product specifications.

This application claims priority to U.S. Patent Application Ser. No. 61/949,055, filed Mar. 6, 2014, and incorporated herein by this reference in its entirety.

### BACKGROUND OF THE INVENTION

The present invention relates generally to antimicrobials for meat products and, more specifically, to a natural, vinegar-based antimicrobial for protecting meat products from food pathogens.

Development of new ingredients to inactivate Listeria monocytogenes in ready-to-eat (RTE) meats represents a high priority for the meat industry. Consumer expectations regarding the safety, quality, and shelf-life of foods are always increasing. Currently, consumers want clean-label ingredients in their food products with fewer synthetic additives. Research studies have shown preferences for natural and organic foods based on concerns about pesticides, antibiotics, hormones, genetic modifications, and chemical additives (Sebranek, J., and J. Bacus. 2007. Natural and Organic Cured Meat Products: Regulatory, Manufacturing, Marketing, Quality and Safety Issues. White paper. American Meat Science Association). In order to meet the growing demand for non-synthetic, label-friendly ingredients, a buffered-vinegar, antimicrobial system for controlling food pathogens in meat and poultry products has been developed. Listeria challenge studies on meat products, including turkey salami, pork loin, ready-to-eat low-sodium turkey and cured turkey showed that the novel product protected against contamination by Salmonella spp. and controlled Listeria monocytogenes for 14 weeks when stored at 4° C.

### SUMMARY OF THE INVENTION

The present invention consists of a vinegar-based antimicrobial for protecting meat products against food pathogens. Vinegar is partially neutralized using mild bases and then dried to remove water. Vinegar is applied to the dried, buffered composition to produce a standardized liquid product.

The novel product protects meat and poultry products against Listeria spp. and Salmonella spp.

### BRIEF DESCRIPTION OF THE FIGURES

FIG. 1 is a chart of the average change in Listeria monocytogenes on inoculated turkey salami stored at 4° C. for 14 weeks. Turkey salami was treated with 0.75% WTI DV, 0.75% BactoCEASE NV Dry and 3.5% Optiform PD4 and then inoculated with a five strain mixture of Listeria monocytogenes with a target of 5 log CFU/100 g and analyzed for Listeria monocytogenes counts. Error bars represent the mean±standard deviation of one replication (three samples per testing interval in one replication, n=1)

FIG. 2 is a chart of the average change in Listeria monocytogenes on inoculated cured turkey stored at 4° C. for 14 weeks. Cured turkey was treated with 0.75% WTI DV, 0.75% BactoCEASE NV Dry and 3.5% Optiform PD4 and then inoculated with a five strain mixture of Listeria monocytogenes with a target of 5 log CFU/100 g and analyzed for Listeria monocytogenes counts. Error bars represent the mean±standard deviation of one replication (three samples per testing interval in one replication, n=1).

FIG. 3 is a chart of the average change in Salmonella Typhimurium on inoculated pork chops stored at 4° C. for 5 weeks. Enhanced pork loins were treated with various antimicrobials and then inoculated with Salmonella Typhimurium with a target of 5 log CFU/100 g and analyzed for Salmonella Typhimurium counts. Error bars represent the mean±standard deviation of three replications (two samples per testing interval in three replications, n=3).

FIG. 4 is a chart of the average change in Escherichia coli O157:H7 on inoculated pork chops stored at 4° C. for 5 weeks. Enhanced pork loins were treated with various antimicrobials and then inoculated with Escherichia coli O157:H7 with a target of 5 log CFU/100 g and analyzed for Salmonella Typhimurium counts. Error bars represent the mean±standard deviation of three replications (two samples per testing interval in three replications, n=3).

FIG. 5 is a chart of the results of Aerobic plate counts of pork chops stored at 4° C. for 5 weeks. Enhanced pork loins were treated with various antimicrobials and then tested for APC counts at weekly intervals. Error bars represent the mean±standard deviation of three replications (two samples per testing interval in three replications, n=3).

FIG. 6 is a chart of the pH results of pork chops stored at 4° C. for 5 weeks. Enhanced pork loins were treated with various antimicrobials and then tested for pH at weekly intervals. Error bars represent the mean±standard deviation of three replications (two samples per testing interval in three replications, n=3).

FIG. 7 is a chart of the average change in Listeria monocytogenes (Univ. of Wisconsin strains) on inoculated uncured turkey stored at 4° C. for 12 weeks. Uncured turkey was treated with NV Dry at 0.4%, 0.6% and 0.8%; NVK Dry at 0.5%, 0.7% and 0.9% and then inoculated with Listeria monocytogenes with a target of 5 log CFU/100 g and analyzed for Listeria monocytogenes counts. Untreated, inoculated turkey served as a negative control. Error bars represent the mean±standard deviation of three replications (three samples per testing interval in each replication, n=3).

FIG. 8 is a chart of the average change in Listeria monocytogenes (ISU strains) on inoculated uncured turkey stored at 4° C. for 12 weeks. Uncured turkey was treated with NV Dry at 0.4%, 0.6% and 0.8%; NVK Dry at 0.5%, 0.7% and 0.9% and then inoculated with Listeria monocytogenes with a target of 5 log CFU/100 g and analyzed for Listeria monocytogenes counts. Untreated, inoculated turkey served as a negative control. Error bars represent the mean±standard deviation of three replications (three samples per testing interval in each replication, n=3).

FIG. 9 is a chart of the average log counts of Lactic acid bacteria in uninoculated uncured turkey samples stored at 4° C. for 12 weeks from three replications. Uncured turkey was treated with NV Dry at 0.4%, 0.6% and 0.8%; NVK Dry at 0.5%, 0.7% and 0.9% and analyzed for Lactic acid bacteria counts. Turkey without antimicrobial served as an untreated control. Error bars represent the mean±standard deviation of three replications (two samples per testing interval in each replication, n=3).

FIG. 10 is a chart of the pH results of uninoculated uncured turkey samples stored at 4° C. for 12 weeks from three replications. Uncured turkey was treated with NV Dry at 0.4%, 0.6% and 0.8%; NVK Dry at 0.5%, 0.7% and 0.9% and analyzed for pH. Turkey without antimicrobial served as an untreated control. Error bars represent the mean±standard deviation of three replications (two samples per testing interval in each replication, n=3).

FIG. 11 is a chart of the average log counts of Aerobic plate counts in uninoculated uncured turkey samples stored at 4° C. for 12 weeks from three replications. Uncured turkey was treated with NV Dry at 0.4%, 0.6% and 0.8%; NVK Dry at 0.5%, 0.7% and 0.9% and analyzed for Aerobic plate counts. Turkey without antimicrobial served as an untreated control. Error bars represent the mean±standard deviation of three replications (two samples per testing interval in each replication, n=3).

FIG. 12 is a chart of the average sensory scores of uninoculated uncured turkey samples stored at 4° C. for 12 weeks from three replications. Uncured turkey was treated with NV Dry at 0.4%, 0.6% and 0.8%; NVK Dry at 0.5%, 0.7% and 0.9% and tested for sensory (n=9). Turkey without antimicrobial served as an untreated control. Error bars represent the mean±standard deviation of three replications.

### DESCRIPTION OF THE INVENTION

As used in this application, the following terms have the meanings set out below. The amount of the compositions of the present invention to be used in particular applications according to the invention may be readily determined by a person skilled in the art, as a function of the nature of the composition used and/or the desired effect. In general, this amount may be between 0.01% and 2% by weight relative to the total weight of the food product being treated, in particular between 0.2% and 1.5% by weight, preferably between 0.5% and 1% by weight and preferentially between 0.6% and 0.9% by weight.

The term “effective dose” or “effective amount” refers to an amount effective, at dosages and for periods of time necessary, to achieve the desired result. The effective amount of compositions of the invention may vary according to factors such as the composition or formulation of the product being treated with the compositions of the present invention.

In preferred embodiments of the present invention, the effective amount of a blend of carvacrol and caprylic acid ranges from 0.01% and 2% by weight of the products being treated and all values between such limits, including, for example, without limitation or exception, 0.02%, 0.104%, 0.132%, 0.217%, 0.336%, 0.489%, 1.377% and 1.990%. Stated another way, in preferred embodiments of the invention, the dosage can take any value “a.bc” % wherein a is selected from the numerals 0, 1 and 2, and b and c are each individually selected from the numerals 0, 1, 2, 3, 4, 5, 6, 7, 8 and 9, with the exception that c cannot be less than 1 if a, b, c and d are all 0.

Where ranges are used in this disclosure, the end points only of the ranges are stated so as to avoid having to set out at length and describe each and every value included in the range. Any appropriate intermediate value and range between the recited endpoints can be selected. By way of example, if a range of between 0.1 and 1.0 is recited, all intermediate values (e.g., 0.2, 0.3. 6.3, 0.815 and so forth) are included as are all intermediate ranges (e.g., 0.2-0.5, 0.54-0.913, and so forth).

Compositions of the present invention are preferably made in a three-step process involving buffering of a vinegar with one or more bases to produce a solution containing acetic acid and the salt or salts of the bases, removal of water from the buffered vinegar, and standardization of the dehydrated buffered vinegar with a vinegar and/or additional base to achieve a desired amount of acetic acid, moisture and a desired pH.

The term “vinegar” means a composition comprising acetic acid and water. Included is so-called distilled white vinegar customarily standardized to a specified grain value. The starting amount of vinegar may vary between 25% and 95% of the final product.

The term “base” or “buffering agent” or “buffer” means a compound that has acid-neutralizing properties. Suitable bases include alkali metal hydroxides, alkaline earth metal hydroxides, carbonates and bicarbonates of alkali and alkaline earth metals. The starting amount of base may vary between 25% and 95% of the final product.

The acetic acid level of the products of the present invention may be in the range of 25% to 95% by weight relative to the total weight of the final product, in particular between 45% and 85% by weight, preferably between 60% and 80% by weight and preferentially between 65% and 75% by weight.

The pH of the final product is adjusted to a range of between 2 and 7, in particular between 5 and 6.5 and preferentially between 5.7 and 6.3.

The moisture content of the products of the present invention may be in the range of 2% to 20% of the final product, in particular between 5% and 15%, preferably between 9% and 13% by weight and preferentially between 10.5% and 12.5%.

Manufacturing of the present invention, sometimes referred to herein the commercial product name of a preferred embodiment, NV Dry, involves three principal processing steps: liquid blending (the buffering process), dehydration and standardization. The buffering process refers to partial neutralization of white distilled vinegar (300 grain) with mild bases to produce a solution containing acetic acid and its salts. The dehydration step involved the removal of water from the buffered vinegar using a lyophilizer (pilot scale) or rototherm dryer (commercial scale). The standardization step involved a plating (spraying) process wherein white distilled vinegar (300 grain) was plated on the dried, buffered vinegar (NV Dry base) to meet the target active component as well as other physical and chemical product specifications. A wide variety of starting materials can be used to achieve the desired final products.

The present invention includes a commercial scale manufacturing process of preferred products of the present invention.

### Example 1

### Product Manufacturing

### Materials and Methods

Production of NV Dry.

Raw materials used for the production of NV Dry were: White distilled vinegar-300 grain (RM16833), aqueous sodium hydroxide (50%) (RM06589), sodium bicarbonate (RM16831) and sodium carbonate (RM16430).

Liquid Blending (Buffering Process).

This step involved the blending of white distilled vinegar with three buffering agents. The purpose of using three buffering agents was to comply with the USDA regulation on the contribution of the food grade carrier in the final food. The maximum limit allowed for the carrier in the final food is 0.1%. The raw material quantities used for the batch are shown in Table 1. A stainless steel tank (Serial #01-232-TP, Capacity #8500 gal, Millerbernd Process Systems Inc, Winsted, Minn.) was charged with 8,000 kg of white distilled vinegar and added 840 kg of aqueous sodium hydroxide (50%) followed by immediate recirculation with a tube in shell-type heat exchanger (maintained at 20° C.). While recirculating at approximately 100 gpm, the sodium bicarbonate (840 kg) was added in small increments (22.67 kg) from the top of the vessel. Reaction of sodium bicarbonate with vinegar mixture led to the production of frothy foam produced by the generated carbon dioxide. Hence, after adding each increment of sodium bicarbonate, a hold time of approximately 1 minute was initiated between further additions of the sodium bicarbonate to allow the froth to subside. In a similar way, sodium carbonate (840 kg) was added in small increments of approximately 22.67 kg each. At this stage, the foam production was closely monitored and stopped the addition of sodium carbonate until the foam subsided. The contents were recirculated for approximately 6 hrs until the solution appeared clear without any undissolved powder particles. The temperature of the vinegar mixture was maintained close to the ambient temperature. The pH of the buffered vinegar solution was measured and if not in the targeted range, it was adjusted with sodium hydroxide (50%) or white distilled vinegar (300 grain) until it was in the targeted range. If the pH was in the acceptable range (5.70-6.50), the solution was filtered through filter press (Star filters, Model #30-18A/SP/SS/SF, 1.5 micron, nominal, Hillard Corporation, Elmira, N.Y.) to remove black particles from sodium carbonate. After filtration, the next step was dehydration.

TABLE 1
Raw material quantities (kg) used for
Liquid blending (buffering process)

| Raw materials | Quantity (Kg) |
|---|---|
| White distilled vinegar (for buffering) | 8635.76 |
| Sodium hydroxide (50%) | 839.90 |
| Sodium carbonate | 839.90 |
| Sodium bicarbonate | 839.90 |

Dehydration.

Dehydration was carried out in a Rototherm dryer (Serial #A86136, 20 sq. ft. Artisan Industries Inc, Waltham, Mass.). The film temperature was maintained at approximately 86° C., chamber vacuum was maintained at 5.66 torr and feed pump VFD (Variable Frequency Drive) was maintained at 40 Hz. During dehydration process, 50 gm of dried vinegar powder (NV Dry base) was collected at 1 hr intervals and checked for moisture using moisture analyzer (MB45, Ohaus Inc, Parsippany, N.J.), pH (FE20, Mettler Toledo Inc, Columbus, Ohio) and acetic acid (11 samples were tested) The NV Dry base (2129.79 kg) was collected and dispensed in bag liners with a batch size of 10.0-10.5 kg.

Standardization.

This process consists of three steps: blending before spraying, blending after spraying and milling. This activity was carried out in KANA Dry mixing facility. NV Dry base was divided into three batches (584.51 kg, 856.79 kg and 686.50 kg) as the mixer capacity was 1000 kg.

Blending Before Spraying.

For processing each batch, the mixer was charged with NV Dry base and blended for 20 min. For batch-1, five samples were drawn using a powder sampler (Sampling Systems Ltd, Warwickshire, UK) from distributed locations of the mixer for every 5 min. The samples were checked for pH, moisture and acetic acid (Note—The acetic acid was checked only on the samples taken after 20 min blending). For batches-2 and 3, five samples were drawn for each batch after 30 min blending and a composite sample was made for lab scale plating experiments.

Blending after Spraying.

To determine the blending rate of applied white distilled vinegar, lab scale experiments were carried out by blending NV Dry base with white distilled vinegar at 10%, 12.5% and 15% and the blended batches were tested for pH, moisture and acetic acid content (Table 5). The prototype formulation which best met the target specifications was used for the scale up formulation. After determining the blend rate for the three batches, the mixer was started and white distilled vinegar (roughly half the total quantity to be applied i.e. 36.5 kg, 42.8 kg and 42.9 kg for batches-1, 2 and 3 respectively) was sprayed on to NV Dry base and subsequently blended for approximately 5 min. The remaining quantity of white distilled vinegar was sprayed and blended for an additional 5 min. Later, the mixer blades, shaft and walls were scraped to remove any sticking material and the mixture was blended for another 25 minutes (Total blend time—35 min). Five samples were drawn for testing for pH, moisture and acetic acid. The mixture was milled and passed through the screen (0.109 inch size) and collected in 1,000 kg bulk bag. Samples from the bulk bag were collected for testing. The final product was packed in 50 lb Kraft paper bag.

### Results

pH and Acetic Acid Results of Buffered Vinegar Solution.

pH of the buffered vinegar solution was within the specifications (5.70-6.50). Acetic acid content was found to be 23.9%.

TABLE 2
pH of buffered vinegar solution

| Product | pH | Acetic acid (%) |
|---|---|---|
| Buffered vinegar | 5.79 | 23.9 |

Analytical Results of in Process NV Dry Base Samples Collected During Dehydration.

Ranges of pH, moisture and acetic acid are shown in Table 3. The total quantity of NV Dry base obtained after dehydration was 2127.79 kg.

TABLE 3
Analytical results of In-process NV
Dry base samples after dehydration

| Parameter | Results |
|---|---|
| Acetic acid (%) | 67.30-71.0 |
| pH (10% solution) | 5.96-8.19 |
| Moisture (%) | 0.28-24.67 |
| Yield (kg) | 2127.79 |

Analytical Results of NV Dry Base Samples of Three Batches after Blending (Before Spraying).

TABLE 4
Analytical results of NV Dry base samples of three
batches after blending (before spraying)

| Parameter | Batch-1^{a} | Batch-2^{b} | Batch-3^{b} |
|---|---|---|---|
| Acetic acid (%) | 70.18 | 69.00 | 70.20 |
| pH | 6.93 | 6.66 | 6.75 |
| Moisture (%) | 1.93 | 4.20 | 3.01 |

^{a}Batch-1 was blended for 20 minutes
^{b}Batches-2 and 3 were blended for 30 minutes

Lab Scale Spraying Results of Three Batches with Different Blend Rates of White Distilled Vinegar (300 Grain).

From these experiments, it was determined the level of vinegar to add to each batch to best fit the finished product specification. Table 5 represent the spraying results of three batches with different blend rates of white distilled vinegar (300 grain) on a lab scale and Table 6 represents the production batch sizes and blend rate for vinegar added.

TABLE 5
Lab scale spraying results of three batches with different
blend rates of white distilled vinegar (300 grain)

| Parameter | pH | Moisture (%) | Acetic acid (%) |
|---|---|---|---|
| Batch-1 | | | |
| 10% | 6.01 | 9.54 | 67.10 |
| 12.5% | 5.93 | 10.38 | 66.30 |
| 15% | 5.87 | 11.66 | 67.40 |
| Batch-2 | | | |
| 10% | 6.00 | 12.43 | 65.90 |
| 12.5% | 5.91 | 13.88 | 64.40 |
| 15% | 5.82 | 15.59 | 64.50 |
| Batch-3 | | | |
| 10% | 6.01 | 10.87 | 68.80 |
| 12.5% | 5.91 | 12.22 | 65.10 |
| 15% | 5.85 | 13.61 | 65.60 |

TABLE 6
Quantities of three production batches and white
distilled vinegar (300 grain) blend rates

| Parameter | Batch-1 | Batch-2 | Batch-3 |
|---|---|---|---|
| Quantity (kg) | 584.51 | 856.79 | 686.50 |
| Blend rate (%) | 12.5 | 10.0 | 12.5 |

Analytical Results of NV Dry Base Samples of Three Batches after 35 Min Blending (after Spraying)

TABLE 7
Analytical results of NV Dry base samples of three
batches after 35 min blending (after spraying)

| Parameter | Batch-1 | Batch-2 | Batch-3 |
|---|---|---|---|
| Acetic acid (%) | 68.36 ± 0.99 | 68.28 ± 0.78 | 65.76 ± 1.32 |
| pH | 6.03 ± 0.07 | 6.00 ± 0.04 | 5.97 ± 0.06 |
| Moisture (%) | 11.11 ± 1.29 | 11.36 ± 1.69 | 12.54 ± 2.64 |

Analytical Results of Final NV Dry Product after Milling.

The results of all the three batches met the specifications for release. For batch-2, a second milling was tried to see if there is any improvement in RSD (relative standard deviation) compared to single milling (data not shown).

TABLE 8
Analytical results of final product after single milling

| Parameter | Batch-1 | Batch-2 | Batch-3 |
|---|---|---|---|
| Acetic acid (%) | 66.83 ± 0.65 | 65.62 ± 0.10 | 66.61 ± 0.38 |
| pH | 6.00 ± 0.03 | 5.94 ± 0.01 | 5.94 ± 0.03 |
| Moisture (%) | 11.24 ± 1.05 | 12.71 ± 0.17 | 12.08 ± 0.58 |

### Discussion

Three batches of NV Dry were manufactured using three principal processing steps: liquid blending (buffering process), dehydration and standardization. In the buffering step, the pH of the buffered vinegar solution was 5.79 and was within the expected pH range (5.70-6.50). The pH, moisture and acetic acid of the NV Dry base samples collected during dehydration process were in the range of 5.96-8.19, 0.28-24.67%, and 67.3-71.0% respectively. The reason for wide range of moisture results was due to improper feed rate to the dryer at some intervals which was promptly adjusted. 2,127.79 kg of NV Dry base was produced which was further divided into three batches for further processing. In the standardization step, the blend time for batch-1 was 20 min and the respective blend time for the remaining two batches was 30 minutes each. The blending time was increased for the remaining batches to reduce agglomeration. The vinegar application rate was 12.5% (by weight) for batches-1 and 3 and 10% (by weight) for batch-2 and these application rates were chosen to make sure that the final product results are within the specifications. The blending time after vinegar spraying for the three batches was 35 min. After blending, the batches were milled before packaging in bulk bags. For batch-2, a second milling process was completed to see if there was improvement in its assay result RSD compared to the single-milling approach, however no difference was observed between single and double milling (data not shown). For batch-3, three samples each were collected following milling, from the top and middle portion of each of the bulk bags. No differences were observed in the analytical results across the regions (data not shown). All the three batches have met the physical and chemical specifications required for release. After determining the vinegar blend rate, the NV Dry base should be blended for 30 minutes before spraying and 35 minutes after spraying followed by milling, screening and packing in relevant SKU's. From this trial, it can be demonstrated that under the conditions described in this study, the final product complying the laid specifications can be manufactured.

### Example 2

### Application to Oven-Roasted Turkey Breast

### Materials and Methods

Production of Cured Turkey Treatments.

Three different antimicrobial treatments on cured turkey were tested: 0.75% WTI DV (WTI Inc, GA), 0.75% BactoCEASE NV Dry (M016942, Lot no. 31612) and 3.5% Optiform PD4 (blend of 56% potassium lactate+4% sodium diacetate solution, Purac Inc, Lincolnshire, Ill.). The treatments were initially blindly labeled and later decoded by the customer after completion of the study. The customer was not interested in providing the untreated control without antimicrobial treatment due to logistical concerns. Meat treatments were produced under Good Manufacturing Practices in a pilot facility of Butterball LLC, Mount Olive, N.C. The cured turkey treatment made with 3.5% Optiform PD4 served as a positive control. The ingredient statement for the lactate control states: Turkey breast, turkey broth, 2% or less of dextrose, modified food starch, potassium lactate, salt, carrageenan, sodium diacetate, sodium erythorbate, sodium nitrite, sodium phosphate and natural flavor. The ingredient statement for the remaining two treatments was similar to the lactate control except the former had dry vinegar instead of lactate. Chilled (4° C.), sliced products were packaged and shipped overnight under refrigeration. Products were stored at 4° C. until inoculation and were used within one week after production. The study consisted of only one replication. The cured turkey treatments along with the active ingredient and the target concentration are listed in Table 9.

TABLE 9
Cured turkey treatments with the active
ingredient and its target concentration

| | Active | Target |
|---|---|---|
| Description | ingredients | concentration |
| 0.75% WTI DV | Acetic acid | 0.48% Acetic acid |
| 0.75% BactoCEASE | Acetic acid | 0.53% Acetic acid |
| NV Dry | | |
| 3.5% Optiform PD4 | Potassium | 1.96% Potassium |
| | lactate and | lactate and |
| | sodium | 0.14% sodium |
| | diacetate | diacetate¹ |

¹0.14% sodium diacetate is equivalent to 0.12% acetic acid

Preparation of Listeria Inocula.

The five strains of Listeria monocytogenes used in this study were LM 101 (hard salami isolate, serotype 4b), LM 108 (hard salami isolate, serotype 1/2a), LM 310 (goat milk cheese isolate, serotype 4), FSL-C1-109 (hotdog outbreak isolate) and V7 (raw milk isolate, serotype 1). The strains were provided by Dr. Kathy Glass (Assistant Director, Food Research Institute, University of Wisconsin, Madison, Wis.). A single bead of each strain from the reference cryovial (Prolab Diagnostics, Canada) stored at −80° C. was aseptically transferred to 10 ml tryptic soy broth (TSB) (Bacto, BD Biosciences, Sparks, Md.) and incubated at 37° C. for 18-20 h. A passage of the overnight culture was made by transferring 100 μl into 10 ml of fresh TSB in an Erlenmeyer flask. This was incubated aerobically at 37° C. with agitation at 100 rpm in a shaker incubator (Innova 2000 Platform Shaker, New Brunswick Scientific, NJ) for 18-24 h. Cells were harvested by centrifugation (2500×g, 20 min) and suspended in 4.5 ml 0.1% buffered peptone water (pH 7.2). Equivalent populations of each isolate were combined to provide a five-strain mixture of Listeria monocytogenes. Populations of each strain and the mixture were verified by spread plating on pre-poured plates of trypticase soy agar (BBL, BD Biosciences, Sparks, Md.) and modified Oxford agar (Listeria Selective Agar base, Difco, BD Biosciences, Sparks, Md.). The media was prepared as per the manufacturer's instructions.

Listeria Inoculation and Testing.

Slices were surface inoculated with a five strain mixture of Listeria monocytogenes to provide approximately 5 log CFU per 100-g package (equivalent to 3 log CFU per ml of rinse material when using 100 ml rinse for testing). For each package, a total 0.5 ml liquid inoculum was distributed over the top surface of each slice, and slices were stacked so the inoculum was between the slices (typically 5 slices per package, 98-104 g/package). Inoculated products were vacuum packaged (C100 Multivac, Sepp Haggemuller KG, Wolfertschewenden, Germany) in gas-impermeable pouches (3 mil high barrier nylon/EVOH/PE vacuum pouches, Prime Source, Kansas), and stored at 4° C. for up to 14 weeks. Uninoculated samples without additional moisture were similarly packaged and stored at 4° C. for lactic acid bacteria and pH analysis.

Triplicate inoculated samples for each treatment were assayed for changes in Listeria monocytogenes populations, and duplicate uninoculated samples were assayed for changes in lactic acid bacteria and pH at 0-time, and at 2, 4, 6, 8, 10, 12 and 14 weeks storage at 4° C. In addition, changes in odor, appearance, and turbidity in the package exudate were noted for all samples.

Bacterial populations were determined in rinse material obtained after adding 100 ml of sterile Butterfield phosphate buffer to each package and massaging the contents externally by hand for about three minutes. Listeria monocytogenes was enumerated by surface plating serial (1:10) dilutions of rinse material on duplicate plates of modified Oxford agar. Sampling was discontinued for a formulation if there was obvious Listeria monocytogenes growth (e.g. increase >1-log CFU/pkg for two or more consecutive sampling intervals or >2-log increase). For plotting the results, the Listeria counts of each treatment over the period were averaged for one replication and then change from initial (time 0) Listeria counts was determined. Results of the positive control were compared to the Optiform 2007 Listeria control model which predicts the average time for 1 log increase in a particular meat product based on the input values of temperature, pH, salt, moisture and nitrite contents (Purac America, Inc. 2007. Purac Opti. Form Listeria control model information sheet. Available at http://www.purac.com/_sana_/handlers/getfile.ashx/61715659-482d-46cf-a465-306a2bd66d2c/EN-Opti.Form_{—}Listeria_Control_Model_{—}2007.pdf). Changes in pH and populations of competitive microflora (Lactic acid bacteria) were evaluated on uninoculated samples to determine the effect of the experimental treatments on the growth of spoilage microorganisms that may ultimately affect the growth of Listeria monocytogenes.

The pH was measured on the slurry obtained by removing 10 g of the uninoculated samples (used for measuring lactic acid bacteria) and homogenizing with 90 ml deionized water using a lab blender (Stomacher 400, A.J. Seward, London, England). For assaying lactic acid-producing bacteria, the remaining portion of the uninoculated samples were rinsed with sterile Butterfield phosphate buffer, and the rinse material was plated on All Purpose Tween agar (APT agar, Difco, Becton Dickinson, Sparks, Md.) with 0.002% bromcresol purple (25° C., 48-72 h). Counts were not completed on APT agar for inoculated samples because the agar is not selective and does not differentiate between populations of Listeria monocytogenes versus lactic acid producing and other spoilage bacteria. Changes in odor and appearance (including notation for turbidity of package liquid) were recorded for all packages tested.

Proximate and Active Ingredient Analysis.

Triplicate uninoculated samples of each treatment were analyzed in-house for moisture (AOAC International. 2000. Official methods of analysis, 17^{th} ed. AOAC International, Gaithersburg, Md.) (5 h, 100° C., vacuum oven method 950.46), water activity and pH. Single sample of each treatment were analyzed for protein (Combustion—AOAC 990.03), fat (Fat in meat—AOAC 960.39) and sodium content (ICP-AOAC-965.17/985.01 mod.) by a commercial laboratory. Acetic acid was analyzed in-house for a single sample of each treatment at 0 and 14 weeks. Lactic acid was not analyzed.

Instrumental Color Measurement.

Commission Internationale de l′Eclairage (CIE) L*, a*, b* values (lightness, redness, yellowness, respectively) were measured on each sample using a Hunterlab ColorFlex® Colorimeter (Hunter Associates Laboratory, Reston, Va.). Color was measured in triplicate uninoculated samples for each treatment at 0, 4, 8, and 14 weeks. Color was measured on the slices after removing from the package.

Purge Loss (Water Holding Capacity).

Purge loss was determined on triplicate samples of each treatment at 0, 4, 8 and 14 w by a weight difference method. Each pre-packaged treatment sample was measured to determine gross weight. The samples were removed from the package, blotted dry with paper towels for 10 seconds, and a net sample weight was recorded. The packaging was dried with a paper towel and reweighed to determine net packaging weight. Sufficient care was taken to ensure that the package was completely dried. Differences were calculated to determine percent purge loss using equation:

$$\frac{[ Gross weight - packaging weight - sample weight ]}{[ Gross weight ]} \times 100.$$

Sensory.

Informal sensory evaluation was conducted using rank preference testing at 0 and 14 weeks. The three treatments were blindly labeled and presented to ten and six untrained panelists at 0 and 14 weeks respectively. Panelists were asked to rank the samples in order of preference, with 1=most preferred, and 3=least preferred. Panelists were asked to cleanse their palate between samples with unsalted crackers and water.

### Results

Active Ingredients.

Measurements of acetic acid (Table 10) in the cured turkey treatments were within the expected range.

TABLE 10
Active ingredient results in cured turkey treatments.¹

| | Active | Target | Acetic acid |
|---|---|---|---|
| Description | ingredient | concentration | Result (%) |
| 0.75% WTI DV | Acetic acid | 0.48% Acetic acid | 0.51 ± 0.01 |
| 0.75% BactoCEASE | Acetic acid | 0.53% Acetic acid | 0.57 ± 0.01 |
| NV Dry | | | |
| 3.5% Optiform PD4 | Potassium | 1.96% Potassium | 0.12 ± 0.01 |
| | lactate and | lactate and | |
| | sodium | 0.14% sodium | |
| | diacetate | diacetate | |

¹Results are an average ± standard deviation of duplicate samples for one replication

Proximate Analysis.

Results of proximate analysis of cured turkey treatments are shown in Table 11.

TABLE 11
Average values of proximate analysis in cured turkey treatments.¹

| | Treatment | | | |
|---|---|---|---|---|
| | 0.75% WTI | 0.75% BactoCEASE | 3.5% Optiform | Overall |
| Parameter | DV | NV Dry | PD4 | Average |
| Water activity | 0.969 ± 0.000 | 0.972 ± 0.002 | 0.970 ± 0.001 | 0.970 ± 0.002 |
| Moisture (%) | 76.90 ± 0.01 | 76.38 ± 0.08 | 74.48 ± 0.03 | 75.92 ± 1.11 |
| pH | 6.55 ± 0.01 | 6.59 ± 0.00 | 6.48 ± 0.01 | 6.54 ± 0.05 |
| Sodium (%) | 0.92 | 0.97 | 0.71 | 0.87 |
| Fat (%) | 3.25 | 2.96 | 3.21 | 3.14 |
| Protein (%) | 14.16 | 15.03 | 14.77 | 14.65 |

¹Results are an average ± standard deviation of triplicate samples for one replication except for sodium, fat and protein which were analyzed on a single sample.

Inhibition of Listeria monocytogenes.

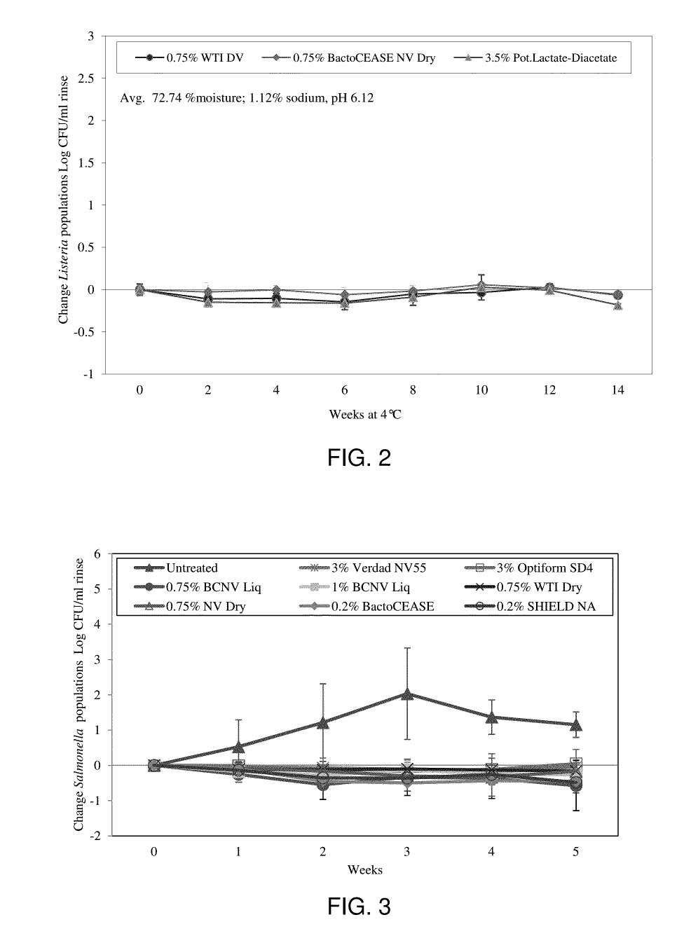

FIG. 2 shows the efficacy results of the three treatments. BactoCEASE NV Dry and WTI Dry treatments showed <1 log increase in Listeria monocytogenes for 14 weeks. Similar results were seen with positive control which showed <1 log increase in Listeria monocytogenes for 14 weeks. The OptiForm 2007 model predicted a 1-log increase for a similar product containing 3.5% Optiform PD4 in approximately 8.5-12 weeks (60-83 d) stored at 4° C. For a similar product without any antimicrobial, the model predicted a 1-log increase in approximately 2.5-3.5 weeks (18-25 d).

Lactic Acid Bacteria Counts.

Initial counts of lactic acid bacteria (Table 12) for the three treatments were in the range of 0.8-4 log CFU/ml rinse, populations increased to 8 log CFU by the end of 14 weeks for all the treatments.

TABLE 12
Average log counts of Lactic acid bacteria^{a} in uninoculated
cured turkey samples stored at 4° C. for 14 weeks.
Cured turkey was treated with 0.75% WTI DV, 0.75%
BactoCEASE NV Dry and 3.5% Optiform PD4

Treatment

| | 0.75% WTI | 0.75% BactoCEASE | 3.5% Optiform |
|---|---|---|---|
| Weeks | Dry | NV Dry | PD4 |
| 0 | 3.68 ± 0.24 | 0.88 ± 0.04 | 2.88 ± 0.22 |
| 2 | 4.78 ± 0.75 | 2.88 ± 0.52 | 1.74 ± 0.11 |
| 4 | 6.32 ± 0.04 | 5.31 ± 0.01 | 4.38 ± 1.30 |
| 6 | 7.26 ± 0.04 | 7.13 ± 0.01 | 5.38 ± 0.30 |
| 8 | 7.87 ± 0.12 | 7.93 ± 0.08 | 6.44 ± 0.01 |
| 10 | 8.08 ± 0.04 | 7.89 ± 0.06 | 7.55 ± 0.05 |
| 12 | 8.21 ± 0.01 | 8.08 ± 0.02 | 7.88 ± 0.09 |
| 14 | 8.47 ± 0.03 | 8.27 ± 0.03 | 7.84 ± 0.04 |

^{a}Data represent average ± standard deviation of duplicate samples of each treatment at each sampling interval for one replication.

pH.

The pH values (Table 13) of positive control showed a decrease of 0.20 and 0.07 units at the end of 12 and 14 weeks respectively. WTI Dry and BactoCEASE NV Dry treatments showed a decrease of 1.24 and 1.20 units respectively at the end of 14 weeks.

TABLE 13
pH of uninoculated cured turkey samples during 4° C. storage
for 14 weeks. Cured turkey was treated with 0.75% WTI DV, 0.75%
BactoCEASE NV Dry and 3.5% Optiform PD4. Error bars represent
the standard deviation of the mean of one replication (two samples
per testing interval in one replication, n = 1)

Treatment

| | 0.75% WTI | 0.75% BactoCEASE | 3.5% Optiform |
|---|---|---|---|
| Weeks | Dry | NV Dry | PD4 |
| 0 | 6.56 ± 0.00 | 6.59 ± 0.00 | 6.49 ± 0.01 |
| 2 | 6.16 ± 0.04 | 6.38 ± 0.02 | 6.29 ± 0.01 |
| 4 | 5.95 ± 0.05 | 5.91 ± 0.06 | 6.32 ± 0.00 |
| 6 | 5.89 ± 0.08 | 5.93 ± 0.01 | 6.34 ± 0.07 |
| 8 | 5.70 ± 0.03 | 5.82 ± 0.06 | 6.22 ± 0.11 |
| 10 | 5.61 ± 0.01 | 5.62 ± 0.06 | 6.26 ± 0.03 |
| 12 | 5.37 ± 0.04 | 5.40 ± 0.04 | 6.31 ± 0.01 |
| 14 | 5.32 ± 0.03 | 5.39 ± 0.03 | 6.42 ± 0.02 |

Instrumental Color.

Instrumental color measurement results are shown in Tables 14-16. Trends of color results showed no differences between the treatments at each testing interval.

TABLE 14
Instrumental color (L* values) of cured turkey treatments

Weeks (w)

| Treatment | 0 | 4 | 8 | 14 |
|---|---|---|---|---|
| 0.75% WTI Dry | 70.20 | 67.77 | 68.86 | 69.60 |
| 0.75% BactoCEASE NV Dry | 69.24 | 67.14 | 68.17 | 68.53 |
| 3.5% Optiform PD4 | 69.39 | 68.28 | 68.23 | 68.76 |

TABLE 15
Instrumental color (a* values) of cured turkey treatments

Weeks (w)

| Treatment | 0 | 4 | 8 | 14 |
|---|---|---|---|---|
| 0.75% WTI Dry | 5.37 | 1.47 | 1.57 | 1.92 |
| 0.75% BactoCEASE NV Dry | 6.15 | 1.73 | 1.37 | 1.77 |
| 3.5% Optiform PD4 | 6.57 | 3.71 | 2.89 | 3.31 |

TABLE 16
Instrumental color (b* values) of cured turkey treatments

Weeks (w)

| Treatment | 0 | 4 | 8 | 14 |
|---|---|---|---|---|
| 0.75% WTI Dry | 8.94 | 6.21 | 6.60 | 7.10 |
| 0.75% BactoCEASE NV Dry | 8.90 | 6.07 | 6.28 | 6.87 |
| 3.5% Optiform PD4 | 10.47 | 9.30 | 8.66 | 8.64 |

Purge Loss.

Purge loss values of cured turkey treatments are shown in Table 17. Purge loss for the treatments was in the range of 0.65-3.72%.

TABLE 17
Purge loss (%) of cured turkey treatments

Weeks (w)

| Treatment | 0 | 4 | 8 | 14 |
|---|---|---|---|---|
| 0.75% WTI Dry | 1.14 | 1.70 | 3.08 | 3.72 |
| 0.75% BactoCEASE NV Dry | 0.65 | 1.58 | 2.74 | 3.17 |
| 3.5% Optiform PD4 | 1.63 | 1.07 | 2.90 | 2.42 |

Sensory.

Overall rank preference sensory results (Table 18) showed differences between the treatments, with equal preference for BactoCEASE NV Dry and positive control and least preference for WTI Dry.

TABLE 18
Results of the ranked preference sensory
evaluation at 0 and 14 w (n = 10 and n = 6)
Mean sensory scores for each treatment (1 =
most preferred, 3 = least preferred)

| 0.75% WTI Dry | 0.75% BactoCEASE NV Dry | 3.5% Optiform PD4 |
|---|---|---|
| 2.5 | 1.8 | 1.8 |

### Discussion

Statistical analysis of the results could not be performed due to single replication of the study; therefore, conclusions from this study were based on the typical data trends. Efficacy results showed that 0.75% WTI Dry, 0.75% BactoCEASE NV Dry and 3.5% Optiform PD4 treatments controlled Listeria monocytogenes for 14 weeks in cured turkey having 75.92% moisture, pH 6.54 and 0.87% sodium. Lactic acid bacteria in all the treatments grew from 0.8-4 log CFU/ml rinse to 8 log CFU/ml rinse by the end 14 weeks thus indicating the end of product shelf life. The drop in the pH values of the treatments correlated with the increased lactic acid spoilage bacteria and indicated that the turkey samples started to spoil.

Some factors in determining the efficacy of various antimicrobials are moisture, pH, NaCl, added nitrite, storage temperature, and perhaps meat type such as turkey, chicken, ham and beef (Glass, K. A., McDonnell, L. M., Rassel, R. C and Zierke, K. L. 2007. Controlling Listeria monocytogenes on sliced ham and turkey products using benzoate, propionate and sorbate. Journal of Food Protection. 70:2306-2312). Therefore, meat processors should conduct Listeria challenge studies to confirm the antimicrobial application rates are adequate for their specific meat formula. Overall, results of the current challenge study showed a trend that BactoCEASE NV Dry was effective in inhibiting Listeria monocytogenes in RTE cured turkey without impacting its quality and sensory characteristics. The results of this study also indicated that BactoCEASE NV Dry at 0.75% performed equally with 0.75% WTI DV and 3.5% Optiform PD4 in terms of efficacy and quality characteristics. Future challenge studies will focus on meat matrices like uncured turkey, ham, hot dogs and fresh meat products.

### Example 3

### Application to Turkey Salami

### Materials and Methods

Production of Turkey Salami Treatments.

Three different antimicrobial treatments on deli-style turkey salami were tested: 0.75% WTI DV (WTI Inc, GA), 0.75% BactoCEASE NV Dry (MO16942, Lot no. 31612) and 3.5% Optiform PD4 (blend of 56% potassium lactate+4% sodium diacetate solution, Purac Inc, Lincolnshire, Ill.) which served as a positive control. The treatments were initially blindly labeled and later decoded by the customer after completion of the study. The customer was not interested in providing the untreated control without antimicrobial treatment due to logistical concerns. Meat treatments were produced under Good Manufacturing Practices in a pilot facility of Butterball LLC, Mount Olive, N.C. The ingredient statement for the lactate control states turkey thigh meat, water, 2% or less of salt, spices, carrageenan, encapsulated citric acid (citric acid, partially hydrogenated cottonseed and soybean oil), potassium lactate, sodium phosphate, sugar, dehydrated garlic, sodium diacetate, sodium erythorbate and sodium nitrite. The ingredient statement for the remaining two treatments was similar to the lactate control except the former had dry vinegar instead of lactate. Chilled (4° C.), sliced products were packaged and shipped overnight under refrigeration. Products were stored at 4° C. until inoculation and were used within one week after production. The study consisted of only one replication. The turkey salami treatments along with the active ingredient and the target concentration are listed in Table 19.

TABLE 19
Turkey salami treatments with the active
ingredient and its target concentration

| | Active | Target |
|---|---|---|
| Description | ingredients | concentration |
| 0.75% WTI DV | Acetic acid | 0.48% Acetic acid |
| 0.75% BactoCEASE | Acetic acid | 0.53% Acetic acid |
| NV Dry | | |
| 3.5% Optiform PD4 | Potassium | 1.96% Potassium |
| | lactate and | lactate and |
| | sodium | 0.14% sodium |
| | diacetate | diacetate¹ |

¹0.14% sodium diacetate is equivalent to 0.12% acetic acid

Preparation of Listeria Inocula.

The five strains of Listeria monocytogenes used in this study were LM 101 (hard salami isolate, serotype 4b), LM 108 (hard salami isolate, serotype 1/2a), LM 310 (goat milk cheese isolate, serotype 4), FSL-C1-109 (hotdog outbreak isolate) and V7 (raw milk isolate, serotype 1). The strains were provided by Dr. Kathy Glass (Assistant Director, Food Research Institute, University of Wisconsin, Madison, Wis.). A single bead of each strain from the reference cryovial (Prolab Diagnostics, Canada) stored at −80° C. was aseptically transferred to 10 ml tryptic soy broth (TSB) (Bacto, BD Biosciences, Sparks, Md.) and incubated at 37° C. for 18-20 h. A passage of the overnight culture was made by transferring 100 μl into 10 ml of fresh TSB in an Erlenmeyer flask. This was incubated aerobically at 37° C. with agitation at 100 rpm in a shaker incubator (Innova 2000 Platform Shaker, New Brunswick Scientific, NJ) for 18-24 h. Cells were harvested by centrifugation (2500×g, 20 min) and suspended in 4.5 ml 0.1% buffered peptone water (pH 7.2). Equivalent populations of each isolate were combined to provide a five-strain mixture of Listeria monocytogenes. Populations of each strain and the mixture were verified by spread plating on pre-poured plates of trypticase soy agar (BBL, BD Biosciences, Sparks, Md.) and modified Oxford agar (Listeria Selective Agar base, Difco, BD Biosciences, Sparks, Md.). The media was prepared as per the manufacturer's instructions.

Listeria Inoculation and Testing.

Slices were surface inoculated with a five strain mixture of Listeria monocytogenes to provide approximately 5 log CFU per 100-g package (equivalent to 3 log CFU per ml of rinse material when using 100 ml rinse for testing). For each package, a total 0.5 ml liquid inoculum was distributed over the top surface of each slice, and slices were stacked so the inoculum was between the slices (typically 5 slices per package, 98-104 g/package). Inoculated products were vacuum packaged (C100 Multivac, Sepp Haggemuller KG, Wolfertschewenden, Germany) in gas-impermeable pouches (3 mil high barrier nylon/EVOH/PE vacuum pouches, Prime Source, Kansas), and stored at 4° C. for up to 14 weeks. Uninoculated samples without additional moisture were similarly packaged and stored at 4° C. for lactic acid bacteria and pH analysis.

Triplicate inoculated samples for each treatment were assayed for changes in Listeria monocytogenes populations, and duplicate uninoculated samples were assayed for changes in lactic acid bacteria and pH at 0-time, and at 2, 4, 6, 8, 10, 12 and 14 w storage at 4° C. In addition, changes in odor, appearance, and turbidity in the package exudate were noted for all samples.

Bacterial populations were determined in rinse material obtained after adding 100 ml of sterile Butterfield phosphate buffer to each package and massaging the contents externally by hand for about three minutes. Listeria monocytogenes was enumerated by surface plating serial (1:10) dilutions of rinse material on duplicate plates of modified Oxford agar. Sampling was discontinued for a formulation if there was obvious Listeria monocytogenes growth (e.g. increase >1-log CFU/pkg for two or more consecutive sampling intervals or >2-log increase). For plotting the results, the Listeria counts of each treatment over the period were averaged for one replication and then change from initial (time 0) Listeria counts was determined. Results of the positive control were compared to the Optiform 2007 Listeria control model which predicts the average time for 1 log increase in a particular meat product based on the input values of temperature, pH, salt, moisture and nitrite contents (Purac America, 2007). Changes in pH and populations of competitive microflora (Lactic acid bacteria) were evaluated on uninoculated samples to determine the effect of the experimental treatments on the growth of spoilage microorganisms that may ultimately affect the growth of Listeria monocytogenes.

The pH was measured on the slurry obtained by removing 10 g of the uninoculated samples (used for measuring lactic acid bacteria) and homogenizing with 90 ml deionized water using a lab blender (Stomacher 400, A.J. Seward, London, England). For assaying lactic acid-producing bacteria, the remaining portion of the uninoculated samples were rinsed with sterile Butterfield phosphate buffer, and the rinse material was plated on All Purpose Tween agar (APT agar, Difco, Becton Dickinson, Sparks, Md.) with 0.002% bromcresol purple (25° C., 48-72 h). Counts were not completed on APT agar for inoculated samples because the agar is not selective and does not differentiate between populations of Listeria monocytogenes versus lactic acid producing and other spoilage bacteria. Changes in odor and appearance (including notation for turbidity of package liquid) were recorded for all packages tested.

Proximate and Active Ingredient Analysis.

Triplicate uninoculated samples of each treatment were analyzed in-house for moisture (AOAC International, 2000) (5 h, 100° C., vacuum oven method 950.46), water activity and pH. Single sample of each treatment was analyzed for protein (Combustion-AOAC 990.03), fat (Fat in meat—AOAC 960.39) and sodium content (ICP-AOAC-965.17/985.01 mod.) by a commercial laboratory. Acetic acid was analyzed in-house for a single sample of each treatment at 0 and 14 weeks. Lactic acid was not analyzed.

Instrumental Color Measurement.

Commission Internationale de l′Eclairage (CIE) L*, a*, b* values (lightness, redness, yellowness, respectively) were measured on each sample using a Hunterlab ColorFlex® Colorimeter (Hunter Associates Laboratory, Reston, Va.). Color was measured in triplicate uninoculated samples for each treatment at 0, 4, 8, and 14 weeks. Color was measured on the slices after removing from the package.

Purge Loss (Water Holding Capacity).

Purge loss was determined on triplicate samples of each treatment at 0, 4, 8 and 14 weeks by a weight difference method. Each pre-packaged treatment sample was measured to determine gross weight. The samples were removed from the package, blotted dry with paper towels for 10 seconds, and a net sample weight was recorded. The packaging was dried with a paper towel and reweighed to determine net packaging weight. Sufficient care was taken to ensure that the package was completely dried. Differences were calculated to determine percent purge loss using equation:

$$\frac{[ Gross weight - packaging weight - sample weight ]}{[ Gross weight ]} \times 100.$$

Sensory.

Informal sensory evaluation was conducted using rank preference testing at 0 and 14 weeks. The three treatments were blindly labeled and presented to nine and six untrained panelists at 0 and 14 weeks respectively. Panelists were asked to rank the samples in order of preference, with 1=most preferred, and 3=least preferred. Panelists were asked to cleanse their palate between samples with unsalted crackers and water.

### Results

Active Ingredients.

Measurements of acetic acid (Table 20) in the turkey salami treatments were within the expected range.

TABLE 20
Active ingredient results in turkey salami treatments.¹

| | Active | Target | Acetic acid |
|---|---|---|---|
| Description | ingredient | concentration | Result (%) |
| 0.75% WTI DV | Acetic acid | 0.48% Acetic acid | 0.53 ± 0.02 |
| 0.75% BactoCEASE | Acetic acid | 0.53% Acetic acid | 0.56 ± 0.01 |
| NV Dry | | | |
| 3.5% Optiform PD4 | Potassium | 1.96% Potassium | 0.12 ± 0.01 |
| | lactate and | lactate and | |
| | sodium | 0.14% sodium | |
| | diacetate | diacetate | |

¹Results are an average ± standard deviation of duplicate samples for one replication

Proximate Analysis.

Results of proximate analysis of turkey salami treatments are shown in Table 21.

TABLE 21
Average values of proximate analysis in turkey salami treatments.¹

| | Treatment | | | |
|---|---|---|---|---|
| | | 0.75% | 3.5% | |
| | 0.75% WTI | BactoCEASE | Optiform | Overall |
| Parameter | DV | NV Dry | PD4 | Average |
| Water | 0.968 ± 0.001 | 0.967 ± 0.001 | 0.966 ± 0.002 | 0.967 ± 0.001 |
| activity | | | | |
| Moisture (%) | 72.85 ± 0.10 | 72.51 ± 0.05 | 71.35 ± 0.37 | 72.24 ± 0.71 |
| pH | 6.12 ± 0.01 | 6.14 ± 0.01 | 6.09 ± 0.01 | 6.12 ± 0.02 |
| Sodium (%) | 1.19 | 1.22 | 0.96 | 1.12 |
| Fat (%) | 5.62 | 5.86 | 6.24 | 5.91 |
| Protein (%) | 15.66 | 15.41 | 15.79 | 15.62 |

¹Results are an average ± standard deviation of triplicate samples for one replication except for sodium, fat and protein which were analyzed on a single sample.

Inhibition of Listeria monocytogenes.

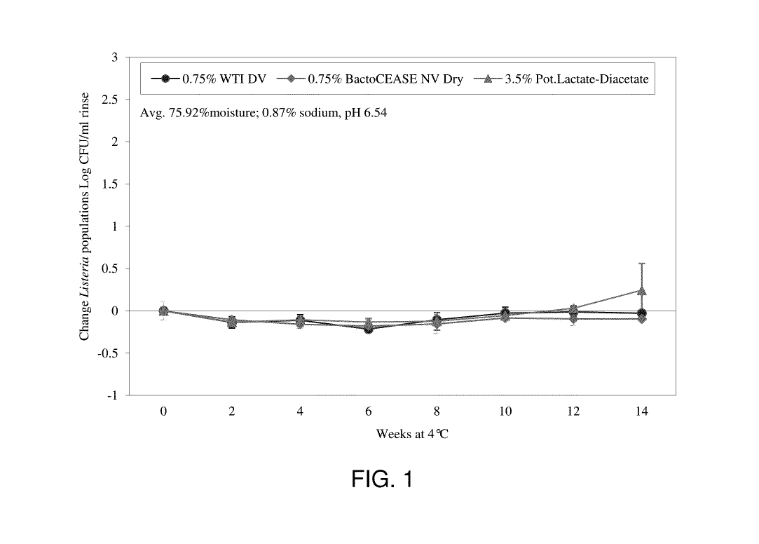

FIG. 1 shows the efficacy results of the three treatments. BactoCEASE NV Dry and WTI Dry treatments showed <1 log increase in Listeria monocytogenes for 14 weeks. Similar results were seen with positive control which showed <1 log increase in Listeria monocytogenes for 14 weeks. The OptiForm 2007 model predicted a 1-log increase for a similar product containing 3.5% Optiform PD4 in approximately 12-16.5 weeks (84-116 d) stored at 4° C. For a similar product without any antimicrobial, the model predicted a 1-log increase in approximately 3.4-4.5 weeks (24-32 d).

Lactic Acid Bacteria Counts.

Initial counts of lactic acid bacteria (Table 22) for the three treatments were in the range of 1-2 log CFU/ml rinse, populations increased to 8 log CFU by the end of 14 weeks for all the treatments.

TABLE 22
Average log counts of Lactic acid bacteria^{a} in uninoculated
turkey salami samples stored at 4° C. for 14
weeks. Turkey salami was treated with 0.75% WTI DV,
0.75% BactoCEASE NV Dry and 3.5% Optiform PD4

Treatment

| | 0.75% WTI | 0.75% BactoCEASE | 3.5% Optiform |
|---|---|---|---|
| Weeks | Dry | NV Dry | PD4 |
| 0 | 1.44 ± 0.06 | 1.57 ± 0.80 | 0.88 ± 0.82 |
| 2 | 3.30 ± 0.07 | 2.68 ± 0.11 | 3.34 ± 0.00 |
| 4 | 5.13 ± 0.11 | 5.03 ± 0.06 | 5.23 ± 0.06 |
| 6 | 7.17 ± 0.18 | 7.18 ± 0.16 | 7.17 ± 0.26 |
| 8 | 7.77 ± 0.13 | 7.78 ± 0.13 | 7.63 ± 0.21 |
| 10 | 7.93 ± 0.08 | 7.88 ± 0.11 | 7.83 ± 0.05 |
| 12 | 8.05 ± 0.09 | 8.02 ± 0.21 | 8.06 ± 0.01 |
| 14 | 8.03 ± 0.05 | 7.79 ± 0.09 | 8.15 ± 0.13 |

^{a}Data represent average ± standard deviation of duplicate samples of each treatment at each sampling interval for one replication.

pH.

The pH values (Table 23) of positive control showed a decrease of 0.53 units at the end of 14 weeks. WTI Dry and BactoCEASE NV Dry treatments showed a decrease of 0.46 and 0.43 units respectively at the end of 14 weeks.

TABLE 23
pH of uninoculated turkey salami samples during 4° C. storage
for 14 weeks. Turkey salami was treated with 0.75% WTI DV, 0.75%
BactoCEASE NV Dry and 3.5% Optiform PD4. Error bars represent
the standard deviation of the mean of one replication (two
samples per testing interval in one replication, n = 1)

Treatment

| | 0.75% WTI | 0.75% BactoCEASE | 3.5% Optiform |
|---|---|---|---|
| Weeks | Dry | NV Dry | PD4 |
| 0 | 6.12 ± 0.01 | 6.14 ± 0.01 | 6.09 ± 0.01 |
| 2 | 5.93 ± 0.00 | 5.95 ± 0.00 | 5.88 ± 0.02 |
| 4 | 5.94 ± 0.01 | 5.95 ± 0.01 | 5.86 ± 0.05 |
| 6 | 5.78 ± 0.11 | 5.80 ± 0.13 | 5.84 ± 0.03 |
| 8 | 5.62 ± 0.03 | 5.61 ± 0.01 | 5.58 ± 0.03 |
| 10 | 5.67 ± 0.01 | 5.62 ± 0.03 | 5.60 ± 0.03 |
| 12 | 5.67 ± 0.06 | 5.61 ± 0.05 | 5.52 ± 0.01 |
| 14 | 5.66 ± 0.03 | 5.71 ± 0.01 | 5.56 ± 0.00 |

Instrumental Color.

Instrumental color measurement results are shown in Tables 24-26. Trends of color results showed no differences between the treatments at each testing interval.

TABLE 24
Instrumental color (L* values) of turkey salami treatments

Weeks

| Treatment | 0 | 4 | 8 | 14 |
|---|---|---|---|---|
| 0.75% WTI Dry | 54.53 | 54.53 | 56.05 | 55.65 |
| 0.75% BactoCEASE NV Dry | 54.96 | 53.60 | 55.70 | 55.25 |
| 3.5% Optiform PD4 | 55.47 | 54.85 | 55.75 | 55.89 |

TABLE 25
Instrumental color (a* values) of turkey salami treatments

Weeks

| Treatment | 0 | 4 | 8 | 14 |
|---|---|---|---|---|
| 0.75% WTI Dry | 10.32 | 10.71 | 10.74 | 10.75 |
| 0.75% BactoCEASE NV Dry | 11.14 | 10.87 | 11.45 | 11.18 |
| 3.5% Optiform PD4 | 11.23 | 10.60 | 11.47 | 11.09 |

TABLE 26
Instrumental color (b* values) of turkey salami treatments

Weeks

| Treatment | 0 | 4 | 8 | 14 |
|---|---|---|---|---|
| 0.75% WTI Dry | 11.57 | 11.33 | 11.84 | 11.22 |
| 0.75% BactoCEASE NV Dry | 11.50 | 11.28 | 11.94 | 11.71 |
| 3.5% Optiform PD4 | 12.01 | 11.25 | 12.15 | 11.94 |

Purge Loss.

Purge loss values of turkey salami treatments are shown in Table 27. Purge loss for the treatments was in the range of 0.5-1.7%.

TABLE 27
Purge loss (%) of turkey salami treatments

Weeks

| Treatment | 0 | 4 | 8 | 14 |
|---|---|---|---|---|
| 0.75% WTI Dry | 0.62 | 0.55 | 0.78 | 0.96 |
| 0.75% BactoCEASE NV Dry | 1.26 | 1.33 | 1.18 | 1.17 |
| 3.5% Optiform PD4 | 0.76 | 0.63 | 1.67 | 1.46 |

Sensory.

Overall rank preference sensory results (Table 28) showed differences between the treatments, with equal preference for WTI Dry and BactoCEASE NV Dry and least preference for positive control.

TABLE 28
Results of the ranked preference sensory
evaluation at 0 and 14 weeks (n = 9 and n = 6)
Mean sensory scores for each treatment (1 =
most preferred, 3 = least preferred)

| 0.75% WTI Dry | 0.75% BactoCEASE NV Dry | 3.5% Optiform PD4 |
|---|---|---|
| 1.9 | 1.9 | 2.3 |

### Discussion

Statistical analysis of the results could not be performed due to single replication of the study; therefore, conclusions from this study were based on the typical data trends. Efficacy results showed that 0.75% WTI Dry, 0.75% BactoCEASE NV Dry and 3.5% Optiform PD4 treatments controlled Listeria monocytogenes for 14 weeks in turkey salami having 72.74% moisture, pH 6.12 and 1.12% sodium. Lactic acid bacteria in all the treatments grew from 1-2 log CFU/ml rinse to 8 log CFU/ml rinse by the end 14 weeks thus indicating the end of product shelf life. The pH values for all the three treatments dropped by 0.4-0.5 units by the end of 14 weeks, which is correlated to increase in the lactic acid bacteria counts.

Some factors in determining the efficacy of various antimicrobials are moisture, pH, NaCl, added nitrite, storage temperature, and perhaps meat type such as turkey, chicken, ham and beef (Glass, et al., 2007). Therefore, meat processors should conduct Listeria challenge studies to confirm the antimicrobial application rates are adequate for their specific meat formula. Overall, results of the current challenge study showed a trend that BactoCEASE NV Dry was effective in inhibiting Listeria monocytogenes in RTE turkey salami without impacting its quality and sensory characteristics. The results of this study also indicated that BactoCEASE NV Dry at 0.75% performed equally with 0.75% WTI DV and 3.5% Optiform PD4 in terms of efficacy and quality characteristics. Future challenge studies will focus on meat matrices like uncured turkey, ham, hot dogs and fresh meat products.

### Example 4

### Application to Pork Loin

### Materials and Methods

Production of Enhanced Pork Loin Treatments.

Nine treatments were manufactured in the meat lab of Mississippi State University, MS under supervision of Dr. Byron Williams (Asst Professor, Muscle Foods Extension/Research). Treatments include an untreated control without any antimicrobial, 0.75% and 1% BactoCEASE NV Liquid (BCNV Liq, Lot no. 1202104691), 0.75% BactoCEASE NV Dry (BCNV Dry, Lot no. 102613), 0.2% BactoCEASE (BC, Lot no. 1209106033), 0.2% SHIELD NA (NA, Lot no. 1301100945); Competitor products were included for comparison purposes—3% Verdad NV55 which contains cultured sugar and vinegar (Verdad, Lot no. 1206002410, Purac America, Lincolnshire, Ill.), 3% Optiform SD4 which contains sodium lactate-sodium diacetate (LD, Lot no. 1110001746, Purac America, Lincolnshire, Ill.) and 0.75% WTI Dry Vinegar (WTI Dry, Lot no. JF-001045). Fresh boneless pork loins (Smartchoice™, Cargill Meat Solutions Corp, Wichita, Kans.) were purchased directly from the packer (Cargill Meat Solutions Corp, slaughtered and processed at Excel Corp, Beardstown, Ill.) and stored at 4° C. The pork loins were enhanced to 110% of original weight by injecting with a brine solution (Table 29) containing water, salt, sodium phosphate and antimicrobial using a needle injector (N40 Schroder, Maschinenbau GMBH, Werther, Germany). The green weight (initial weight of the loins), pump weight (final weight of loins after pumping), % weight gain and pH of brine solutions are shown in Table 30. The desired concentration of salt and sodium phosphate in the final product was 0.3% each. The dosage levels of BactoCEASE™ and the competitor products were selected based on the previous efficacy studies and the manufacturer recommendations respectively. After injection, the loins were vacuum packed (UV 2100, Ultravac, Koch equipment, Kansas City, Mo.) and shipped under refrigerated conditions. The study was replicated thrice by manufacturing the treatments on three different days.

TABLE 29
Composition of brine solution used
for enhanced pork loin treatments

| | Ingredients (lb) | | | |
|---|---|---|---|---|
| | | | Sodium | |
| | Water | Salt | phosphate | Antimicrobial |
| Untreated control | 28.02 | 0.99 | 0.99 | 0.00 |
| 3% Verdad NV55 | 18.12 | 0.99 | 0.99 | 9.90 |
| 3% Optiform SD4 | 18.12 | 0.99 | 0.99 | 9.90 |
| 0.75% BCNV Liq | 25.54 | 0.99 | 0.99 | 2.48 |
| 1% BCNV Liq | 24.72 | 0.99 | 0.99 | 3.30 |
| 0.75% WTI Dry | 25.54 | 0.99 | 0.99 | 2.48 |
| 0.75% BCNV Dry | 25.54 | 0.99 | 0.99 | 2.48 |
| 0.2% BactoCEASE | 27.36 | 0.99 | 0.99 | 0.66 |
| 0.2% SHIELD NA | 27.36 | 0.99 | 0.99 | 0.66 |

TABLE 30
Green weight, pump weight, % weight gain and pH of brine solutions

| | Green weight (lb) | Pump weight (lb) | Weight gain (%) | pH |
|---|---|---|---|---|
| Untreated control | 21.97 ± 1.56 | 24.00 ± 1.51 | 9.30 ± 0.89 | 8.50 ± 0.29 |
| 3% Verdad NV55 | 19.77 ± 1.53 | 21.80 ± 1.68 | 10.29 ± 0.11 | 7.59 ± 0.27 |
| 3% Optiform SD4 | 21.30 ± 0.87 | 23.83 ± 0.46 | 11.96 ± 2.49 | 6.71 ± 0.08 |
| 0.75% BCNV Liq | 18.63 ± 3.19 | 21.00 ± 3.65 | 12.71 ± 2.46 | 6.44 ± 0.09 |
| 1% BCNV Liq | 17.33 ± 2.71 | 19.10 ± 3.05 | 10.16 ± 1.87 | 6.03 ± 0.05 |
| 0.75% WTI Dry | 19.80 ± 2.80 | 21.97 ± 2.73 | 11.11 ± 1.90 | 6.62 ± 0.13 |
| 0.75% BCNV Dry | 21.17 ± 1.95 | 23.23 ± 1.71 | 9.88 ± 2.00 | 6.54 ± 0.14 |
| 0.2% BactoCEASE | 20.97 ± 1.53 | 23.23 ± 1.50 | 10.86 ± 0.99 | 5.67 ± 0.10 |
| 0.2% SHIELD NA | 19.10 ± 1.15 | 21.07 ± 1.25 | 10.30 ± 0.65 | 6.20 ± 0.02 |

¹ Results are an average ± standard deviation for three replications.

Preparation of Salmonella and E. coli Inocula.

Salmonella Typhimurium (ATCC 14028) and Escherichia coli 0157:H7 (ATCC 35150) were purchased from ATCC (Manassas, Va.) and stock cultures were prepared as per the manufacturer instructions. A single bead of each strain from the reference cryovial (Prolab Diagnostics, Canada) stored at −80° C. was aseptically transferred to 10 ml tryptic soy broth (TSB) (Bacto, BD Biosciences, Sparks, Md.) and incubated at 37° C. for 18-20 h. A passage of the overnight culture was made by transferring 100 μl into 10 ml of fresh TSB in an Erlenmeyer flask. This was incubated aerobically at 37° C. with agitation at 100 rpm in a shaker incubator (Innova 2000 Platform Shaker, New Brunswick Scientific, NJ) for 18-24 h. Cells were harvested by centrifugation (2500 rpm, 20 min) and suspended in 4.5 ml 0.1% buffered peptone water (pH 7.2). Populations of Salmonella Typhimurium and Escherichia coli O157:H7 strains were verified by plating on XLD agar (BBL, BD Biosciences, Sparks, Md.) and SMAC agar (Difco, BD Biosciences, Sparks, Md.) respectively and also on general purpose media i.e. Tryptic Soy Agar (TSA, Difco, BD Biosciences, Sparks, Md.).

Pathogen Inoculation and Testing.

Enhanced pork loin treatments were sliced into approximately 1.5 cm thick chops and were surface inoculated with Salmonella Typhimurium and Escherichia coli O157:H7 separately to provide approximately 5 log CFU per 100-g package (equivalent to 3 log CFU per ml of rinse material when using 100 ml rinse for testing). For each package, a total 1.0 ml liquid inoculum was distributed over the surface of each chop, gently massaged for 1 min and vacuum packaged (C100 Multivac, Sepp Haggemuller KG, Wolfertschewenden, Germany) in gas-impermeable pouches (3 mil high barrier nylon/EVOH/PE vacuum pouches, Prime Source, Kansas), and stored at 4° C. for up to 5 weeks. In addition, changes in odor, appearance, and turbidity in the package exudate were noted for all samples.

Salmonella Typhimurium and Escherichia coli O157:H7 populations were determined in rinse material obtained after adding 100 ml of sterile Butterfield phosphate buffer to respective package and massaging the contents externally by hand for about two minutes. Serial (1:10) dilutions of rinse material were spread plated on duplicate plates of XLD and SMAC agar and incubated at 37° C. for 24 h. Duplicate samples were tested for each pathogen and at each testing interval. Sampling was discontinued for a formulation if there was obvious pathogen growth (e.g. increase >1-log CFU/pkg for two or more consecutive sampling intervals or >2-log increase). For plotting the results, the pathogen counts of each treatment over the period were averaged for three replications and then change from initial (time 0) pathogen counts was determined.

Aerobic Plate Counts and pH.

Uninoculated pork chops were vacuum packaged and stored at 4° C. Duplicate samples were assayed for Aerobic plate counts at 0, 1, 2, 3, 4 and 5 weeks by aseptically weighing out 10 grams of sample in a stomacher bag and diluting it with 90 grams of BPB. The contents were stomached at 230 rpm for 30 sec in a lab blender (Stomacher 400, A.J. Seward, London, England) and the rinse material was serially diluted (1:10) in BPB and plated on Plate count agar (PCA, Difco, BD Biosciences, Sparks, Md.) incubated at 37° C. for 48 h. The remaining rinse material was checked for pH (Model FE 20, Mettler-Toledo Inc, Columbus, Ohio).

Proximate and Active Ingredient Analysis.

Duplicate uninoculated samples of each treatment for each replication were analyzed in-house for moisture (5 h, 100° C., vacuum oven method 950.46) and in outside commercial lab for protein (Combustion-AOAC 990.03), fat (Fat in meat—AOAC 960.39) and sodium content (ICP-AOAC-965.17/985.01 mod.). Acetic acid and Propionic acid were analyzed in-house for duplicate samples of each treatment and for each replication. Concentrations of sodium lactate and sodium diacetate were analyzed on single samples of untreated control and 3% Optiform SD4 treatment by a commercial laboratory for each replication (Lactate/Diacetate—JOC (1987) 398:265 analyzed by Silliker labs, Chicago Heights, Ill.).

Instrumental Color Measurement.

Commission Internationale de l′Eclairage (CIE) L*, a*, b* values (lightness, redness, yellowness, respectively) were measured on duplicate uninoculated samples of each treatment using a Hunterlab ColorFlex® Colorimeter (Hunter Associates Laboratory, Reston, Va.). The sample packages were cut open and kept at ambient temperature for 10 min to bloom. The pork chops were removed from the package and color readings were taken at five random surface locations at weekly intervals (0, 1, 2, 3, 4 and 5 weeks).

Purge Loss (Water Holding Capacity).

Purge loss was determined on duplicate samples of each treatment at weekly intervals (0, 1, 2, 3, 4 and 5 weeks) by a weight difference method. Each pre-packaged treatment sample was measured to determine gross weight. The samples were removed from the package, blotted dry with paper towels for 10 seconds, and a net sample weight was recorded. The packaging was dried with a paper towel and reweighed to determine net packaging weight. Differences were calculated to determine percent purge loss as shown below:

Purge loss (%)=[Gross weight (with packaging)−packaging weight−sample weight]÷[Gross weight]×100.

Sensory and Cook Loss.

Informal sensory evaluation was conducted on the uninoculated treatments at 0, 3 and 5 weeks during each replication on a 9 point hedonic scale with 1 being “Dislike Extremely” and 9 being “Like Extremely”. In order to avoid stress on the panelists 5 treatments were subjected to sensory on one day and four treatments on another day. The pork chops were cooked on a grill to an internal temperature of 165° F. and were blindly labeled and presented to 8 panelists. Panelists were asked to cleanse their palate between samples with unsalted crackers and water. Cook loss was determined by weighing the pork chops before and after cooking.

Statistical Analysis.

The microbiological data was reported as average values and standard deviations (log CFU/ml rinse) for duplicate samples and three separate trials (n=3) for each test formulation. Differences between the experimental treatments and the untreated control were analyzed by multifactor analysis of variance (ANOVA) using the STATGRAPHICS® Centurion XV software package (STATPOINT TECHNOLOGIES, INC. 2006. STATGRAPHICS® Centurion XV. Version 15.2.06. Warrenton, Va.). Color, purge loss, cook loss and sensory results were subjected to multifactor analysis of variance. All statistically significant differences in the study were reported at p<0.05 level.

### Results

Proximate and Active Ingredient Results.

Average analytical values of the treatments are shown in Table 31. pH values of the treatments ranged from 5.96±0.11 to 6.33±0.27. Moisture results ranged from 64.93±2.50 to 74.79±0.84%. Sodium content was in the range of 0.23±0.05 to 0.44±0.09. Fat and protein content ranged from 4.20±1.03 to 10.69±3.03% and 18.08±2.24 to 20.77±1.93% respectively. The results of active ingredients (acetic acid, propionic acid and sodium lactate) of the antimicrobial treatments were in the expected range (Table 32).

TABLE 31
Proximate results of enhanced pork loin treatments¹

| | Treatment | | | | |
|---|---|---|---|---|---|
| Parameter | pH | Moisture (%) | Sodium (%) | Fat (%) | Protein(%) |
| Untreated control | 6.31 ± 0.14 | 64.93 ± 2.50 | 0.23 ± 0.05 | 10.69 ± 3.03 | 19.03 ± 1.02 |
| 3% Verdad NV55 | 6.33 ± 0.27 | 66.45 ± 6.55 | 0.35 ± 0.05 | 4.20 ± 1.03 | 19.93 ± 1.76 |
| 3% Optiform SD4 | 6.29 ± 0.28 | 69.21 ± 2.24 | 0.55 ± 0.17 | 5.28 ± 3.43 | 19.66 ± 2.27 |
| 0.75% BCNV Liq | 6.29 ± 0.11 | 72.91 ± 2.90 | 0.35 ± 0.13 | 2.81 ± 0.50 | 19.63 ± 1.60 |
| 1% BCNV Liq | 6.11 ± 0.09 | 68.66 ± 7.01 | 0.36 ± 0.09 | 5.83 ± 2.36 | 18.75 ± 1.69 |
| 0.75% WTI Dry | 6.22 ± 0.20 | 70.79 ± 7.05 | 0.46 ± 0.12 | 8.28 ± 6.20 | 18.08 ± 2.24 |
| 0.75% BCNV Dry | 6.11 ± 0.16 | 72.05 ± 1.81 | 0.44 ± 0.09 | 5.24 ± 1.48 | 20.20 ± 1.57 |
| 0.2% BactoCEASE | 6.26 ± 0.06 | 74.79 ± 0.84 | 0.27 ± 0.04 | 4.70 ± 2.98 | 20.77 ± 1.93 |
| 0.2% SHIELD NA | 5.96 ± 0.11 | 70.60 ± 4.58 | 0.28 ± 0.05 | 5.33 ± 2.66 | 20.39 ± 1.16 |

¹Results are an average ± standard deviation of duplicate samples for three replications.

TABLE 32
% Active results of enhanced pork loin treatments¹

| | Active Ingredient (%) | | |
|---|---|---|---|
| Treatment | Acetic acid | Propionic acid | Sodium lactate |
| Untreated control | <0.01 | <0.01 | 0.48 ± 0.39 |
| 3% Verdad NV55² | 0.08 ± 0.02 | NA | NA |
| 3% Optiform SD4 | 0.10 ± 0.02 | NA | 1.27 ± 0.26 |
| 0.75% BCNV Liq | 0.16 ± 0.05 | NA | NA |
| 1% BCNV Liq | 0.18 ± 0.02 | NA | NA |
| 0.75% WTI Dry | 0.47 ± 0.09 | NA | NA |
| 0.75% BCNV Dry | 0.45 ± 0.16 | NA | NA |
| 0.2% BactoCEASE | NA | 0.10 ± 0.02 | NA |
| 0.2% SHIELD NA | NA | 0.09 ± 0.02 | NA |

¹Results are an average ± standard deviation of duplicate samples for three replications
²Active ingredients in Verdad NV 55 include lactic acid, formic acid, acetic acid, succinic acid, propionic acid and sugars (glucose and fructose)

Inhibition of Salmonella Typhimurium.

Results from the three replications (FIG. 2) showed that at 4° C., the antimicrobial treatments significantly (p<0.05) inhibited the growth of Salmonella Typhimurium compared with the untreated control. The untreated control showed an average log increase of 1.21±1.10, 2.03±1.30, 1.37±0.49 and 1.15±0.36 log CFU/ml rinse by the end of 2, 3, 4 and 5 weeks. The treatments containing the antimicrobials consistently showed <1 log increase for 5 weeks.

Inhibition of Escherichia coli O157:H7.

The antimicrobial treatments significantly (p<0.05) inhibited the growth of Escherichia coli O157:H7 compared with the untreated control. Results from the three replications (FIG. 3) showed that at 4° C., the untreated control showed an average log increase of 1.22±0.43, and 2.01±0.81 log CFU/ml rinse by the end of 4 and 5 weeks. The treatments containing the antimicrobials consistently showed <1 log increase for 5 weeks.

Aerobic Plate Counts and pH.

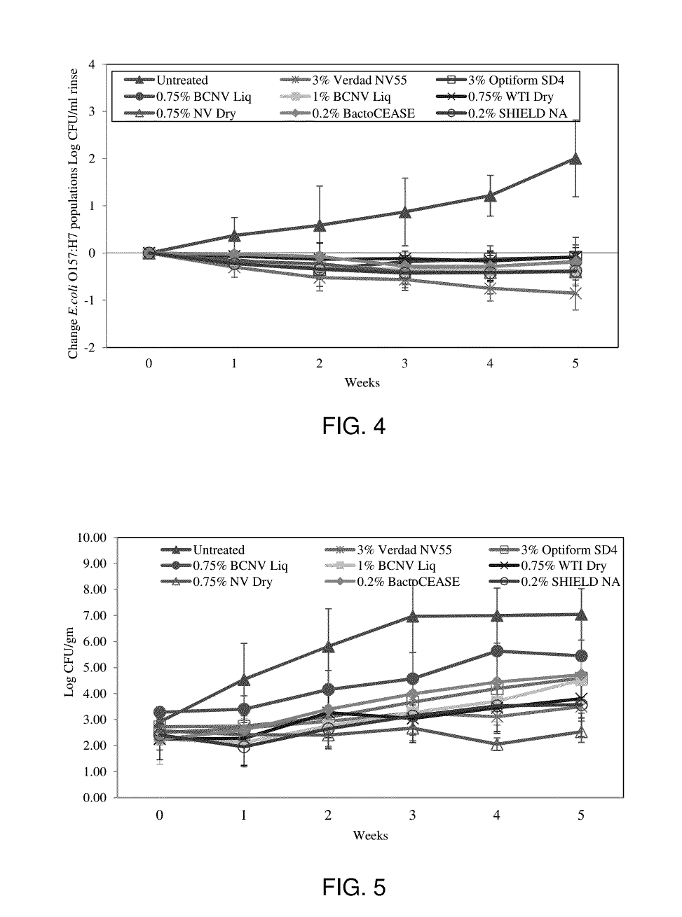

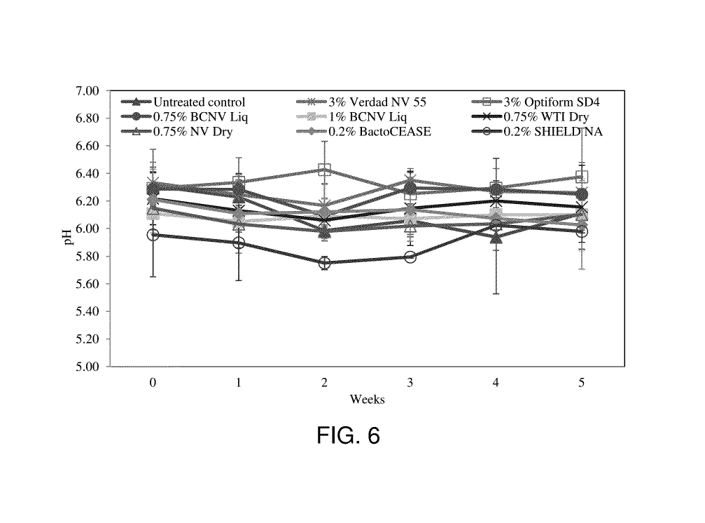

The initial APC counts of all the treatments (FIG. 4) were in the range of 2.23±0.21—3.28±0.21 log CFU/gm. The untreated control reached 7.04±0.99 CFU/gm by the end of 5 weeks. The final counts of antimicrobial treatments were in the range of 2.53±0.41—5.44±1.58 log CFU/gm. The pH results of all the treatments are shown in FIG. 5. Pork loins treated with 0.2% SHIELD NA had the lowest initial pH (5.96±0.31) and maintained a similar trend across the shelf life. pH of the remaining treatments was in the range of 6.11±0.14—6.33±0.24.

Instrumental Color.

Instrumental color measurement results are shown in Tables 33-35. Statistical analysis of L* values showed no significant differences between the following treatments—BCNV Dry-WTI Dry; 0.75% BCNV Liq-1% BCNV Liq; BC-SHIELD NA; Verdad-Optiform. Optiform treatment had lower (p<0.05) L* values when compared with SHIELD NA whereas, no significant differences were seen with 0.75% BCNV Liq (except weeks 2, 4 and 5), 1% BCNV Liq (except week 4), WTI Dry (except week 2), BCNV Dry (except weeks 2 and 4) and BC treatments (except weeks 2 and 4). Verdad treatment had lower (p<0.05) L* values when compared with BC, SHIELD NA and 0.75% BCNV Liq treatments whereas, no significant differences were seen with 1% BCNV Liq (except weeks 0, 1, and 4), WTI Dry (except weeks 2 and 4), and BCNV Dry (except weeks 0, 2, 3 and 4).

TABLE 33
Instrumental color (L* values) of enhanced pork loin treatments

| | Weeks (w) | | | | | | |
|---|---|---|---|---|---|---|---|
| Treatment | 0 | 1 | 2 | 3 | 4 | 5 | SEM |
| Untreated control | 53.57^{cd} | 50.73^{abc} | 53.92^{c} | 53.63^{bc} | 54.30^{c} | 54.17^{abc} | 0.26 |
| 3% Verdad NV55 | 47.67^{a} | 47.30^{a} | 50.36^{a} | 48.78^{a} | 47.81^{a} | 48.24^{a} | 0.19 |
| 3% Optiform SD4 | 49.72^{ab} | 49.78^{ab} | 48.19^{a} | 51.99^{ab} | 50.59^{ab} | 48.86^{a} | 0.31 |
| 0.75% BCNV Liq | 50.07^{abc} | 52.18^{bc} | 54.06^{c} | 53.82^{bc} | 54.84^{c} | 55.73^{c} | 0.31 |
| 1% BCNV Liq | 51.52^{bcd} | 51.30^{bc} | 50.27^{ab} | 52.70^{ab} | 54.58^{c} | 49.89^{ab} | 0.31 |
| 0.75% WTI Dry | 48.86^{ab} | 51.65^{a} | 52.13^{bc} | 50.85^{ab} | 52.64^{bc} | 52.56^{abc} | 0.31 |
| 0.75% BCNV Dry | 51.42^{bcd} | 49.79^{abc} | 52.82^{bc} | 53.45^{b} | 53.97^{c} | 51.31^{abc} | 0.25 |
| 0.2% BactoCEASE | 50.65^{bcd} | 51.99^{bc} | 52.15^{bc} | 53.69^{b} | 54.63^{c} | 52.47^{abc} | 0.25 |
| 0.2% SHIELD NA | 53.50^{d} | 53.36^{c} | 54.37^{c} | 55.52^{c} | 54.81^{c} | 54.35^{bc} | 0.23 |

^{a,b,c,d}Within each column, means with different superscripts are significantly different (p < 0.05)

Statistical analysis of a* values showed no significant differences between the treatments with the following exceptions—Optiform had lower a* values (p<0.05) when compared with 1% BCNV Liq at 0 and 3 weeks; Verdad had higher (p<0.05) a* values when compared with 0.75% BCNV Liq and BC at week-4. 0.75% BCNV Liq differed significantly (p<0.05) with 1% BCNV Liq at weeks 2 and 5 by having lower a* values.

TABLE 34
Instrumental color (a* values) of enhanced pork loin treatments

| | Weeks (w) | | | | | | |
|---|---|---|---|---|---|---|---|
| Treatment | 0 | 1 | 2 | 3 | 4 | 5 | SEM |
| Untreated control | 5.97^{ab} | 7.14^{a} | 8.03^{ab} | 7.52^{ab} | 7.98^{abc} | 7.37^{ab} | 0.11 |
| 3% Verdad NV55 | 7.71^{ab} | 7.88^{a} | 8.93^{ab} | 8.03^{ab} | 9.06^{c} | 7.59^{a} | 0.13 |
| 3% Optiform SD4 | 5.98^{a} | 7.25^{a} | 8.22^{ab} | 5.83^{a} | 7.46^{abc} | 8.08^{ab} | 0.14 |
| 0.75% BCNV Liq | 6.98^{ab} | 8.50^{a} | 7.26^{a} | 7.13^{ab} | 7.11^{ab} | 6.86^{a} | 0.12 |
| 1% BCNV Liq | 7.94^{b} | 8.98^{a} | 9.66^{b} | 8.22^{b} | 7.73^{abc} | 9.26^{b} | 0.15 |
| 0.75% WTI Dry | 6.78^{ab} | 7.19^{a} | 7.99^{ab} | 7.74^{ab} | 8.61^{bc} | 7.38^{ab} | 0.16 |
| 0.75% BCNV Dry | 7.54^{ab} | 9.14^{a} | 7.75^{ab} | 7.62^{ab} | 8.09^{abc} | 8.22^{ab} | 0.10 |
| 0.2% BactoCEASE | 6.18^{ab} | 8.23^{a} | 7.49^{a} | 7.15^{ab} | 6.55^{a} | 7.15^{a} | 0.14 |
| 0.2% SHIELD NA | 6.58^{ab} | 8.32^{a} | 7.61^{a} | 7.60^{ab} | 7.29^{abc} | 8.08^{ab} | 0.12 |

^{a,b,c}Within each column, means with different superscripts are significantly different (p < 0.05)

Statistical analysis of b* values showed no significant differences between the treatments with the following exceptions—Optiform and untreated had lower (p<0.05) b* values when compared with SHIELD NA at week-0; Verdad had higher (p<0.05) b* values when compared with untreated, Optiform, 0.75% and 1% BCNV Liq at week-1.

TABLE 35
Instrumental color (b* values) of enhanced pork loin treatments

| | Weeks (w) | | | | | | |
|---|---|---|---|---|---|---|---|
| Treatment | 0 | 1 | 2 | 3 | 4 | 5 | SEM |
| Untreated control | 13.79^{a} | 14.00^{ab} | 15.48^{a} | 15.13^{a} | 15.41^{a} | 15.56^{a} | 0.12 |
| 3% Verdad NV55 | 14.30^{ab} | 15.04^{c} | 16.21^{a} | 15.17^{a} | 14.84^{a} | 14.60^{a} | 0.13 |
| 3% Optiform SD4 | 13.24^{a} | 12.99^{a} | 14.93^{a} | 14.99^{a} | 14.75^{a} | 14.69^{a} | 0.11 |
| 0.75% BCNV Liq | 14.18^{ab} | 14.27^{b} | 15.29^{a} | 15.17^{a} | 15.84^{a} | 15.55^{a} | 0.12 |
| 1% BCNV Liq | 14.42^{ab} | 14.23^{ab} | 15.07^{a} | 15.20^{a} | 15.01^{a} | 15.56^{a} | 0.11 |
| 0.75% WTI Dry | 13.72^{a} | 15.03^{bc} | 14.88^{a} | 14.54^{a} | 15.37^{a} | 15.59^{a} | 0.13 |
| 0.75% BCNV Dry | 14.20^{ab} | 14.69^{bc} | 14.81^{a} | 15.09^{a} | 15.12^{a} | 15.32^{a} | 0.11 |
| 0.2% BactoCEASE | 14.38^{ab} | 14.95^{bc} | 14.47^{a} | 14.89^{a} | 14.24^{a} | 15.27^{a} | 0.09 |
| 0.2% SHIELD NA | 15.17^{b} | 15.05^{bc} | 14.78^{a} | 16.12^{a} | 15.12^{a} | 16.08^{a} | 0.14 |

^{a,b,c}Within each column, means with different superscripts are significantly different (p < 0.05)

Purge Loss.

Purge loss values of pork loin treatments are shown in Table 36. Statistical analysis of purge loss values showed no significant differences between the following treatments—BCNV Dry-WTI Dry; 0.75% BCNV Liq-1% BCNV Liq; BC-SHIELD NA (except week 0); Verdad-Optiform. Optiform treatment differed significantly (p<0.05) by having lower purge loss values when compared with the following treatments—SHIELD NA at weeks 1, 2, 3, and 4; BC at weeks 3, 4 and 5; 0.75% BCNV Liq at weeks 1, 2, 4 and 5. Verdad treatment had lower (p<0.05) purge loss values when compared with SHIELD NA, BC at weeks 2, 3, 4 and 5; WTI Dry at weeks 2, 4 and 5; 0.75% BCNV Liq at weeks 1, 2, 4, and 5; 1% BCNV Liq at week 5.

TABLE 36
Purge loss (%) of enhanced pork loin treatments

| | Weeks (w) | | | | | | |
|---|---|---|---|---|---|---|---|
| Treatment | 0 | 1 | 2 | 3 | 4 | 5 | SEM |
| Untreated control | 2.28^{ab} | 2.49^{a} | 4.59^{cd} | 3.85^{ab} | 2.84^{abc} | 3.74^{ab} | 0.28 |
| 3% Verdad NV55 | 1.38^{a} | 1.87^{a} | 2.27^{a} | 2.09^{a} | 1.97^{a} | 2.16^{a} | 0.12 |
| 3% Optiform SD4 | 2.41^{ab} | 2.28^{a} | 2.75^{ab} | 2.08^{a} | 2.26^{ab} | 4.31^{abc} | 0.28 |
| 0.75% BCNV Liq | 1.66^{a} | 4.81^{bc} | 4.66^{cd} | 4.21^{ab} | 5.78^{de} | 6.61^{de} | 0.41 |
| 1% BCNV Liq | 2.08^{a} | 2.71^{ab} | 3.80^{abc} | 3.74^{ab} | 4.24^{abcd} | 4.59^{bcd} | 0.29 |
| 0.75% WTI Dry | 1.23^{a} | 2.92^{a} | 4.59^{cd} | 3.58^{ab} | 4.42^{bcd} | 4.94^{bcd} | 0.34 |
| 0.75% BCNV Dry | 2.14^{a} | 3.02^{abc} | 3.49^{abc} | 3.47^{ab} | 3.42^{abcd} | 3.71^{ab} | 0.20 |
| 0.2% BactoCEASE | 1.86^{a} | 3.94^{abc} | 4.43^{bcd} | 5.34^{b} | 4.79^{cde} | 7.83^{e} | 0.40 |
| 0.2% SHIELD NA | 4.90^{b} | 5.65^{c} | 5.60^{d} | 5.53^{b} | 6.42^{e} | 6.39^{cde} | 0.30 |

^{a,b,c,d,e}Within each column, means with different superscripts are significantly different (p < 0.05)

Cook Loss.

Statistical analysis of cook loss values (Table 37) showed no significant differences between the antimicrobial treatments except 1% BCNV Liq had higher (p<0.05) cook loss when compared with Verdad, Optiform, WTI Dry and SHIELD NA at week 0. BC had higher cook loss when compared to Verdad at week-0 and 1% BCNV Liq had higher cook loss when compared to WTI Dry at week-0.

TABLE 37
Cook loss (%) of enhanced pork loin treatments

Weeks (w)

| Treatment | 0 | 3 | 5 | SEM |
|---|---|---|---|---|
| Untreated control | 14.03^{abc} | 24.18^{a} | | 3.01 |
| 3% Verdad NV55 | 9.25^{a} | 16.12^{a} | 13.55^{a} | 2.10 |
| 3% Optiform SD4 | 9.85^{ab} | 14.77^{a} | 9.88^{a} | 1.62 |
| 0.75% BCNV Liq | 11.05^{abc} | 16.23^{a} | 11.56^{a} | 1.63 |
| 1% BCNV Liq | 22.21^{c} | 20.10^{a} | 17.59^{a} | 2.21 |
| 0.75% WTI Dry | 11.48^{ab} | 16.39^{a} | 14.72^{a} | 1.73 |
| 0.75% BCNV Dry | 14.70^{abc} | 13.87^{a} | 15.89^{a} | 1.48 |
| 0.2% BactoCEASE | 19.09^{bc} | 17.22^{a} | 16.62^{a} | 1.50 |
| 0.2% SHIELD NA | 12.67^{ab} | 16.97^{a} | 15.64^{a} | 2.07 |

^{a,b,c}Within each column, means with different superscripts are significantly different (p < 0.05)

Sensory.

No significant differences were observed in the sensory scores (Table 38) except Optiform had higher score when compared with BC at weeks 0 and 3; SHIELD NA at week 0.

TABLE 38
Sensory scores of enhanced pork loin treatments

Weeks (w)

| Treatment | 0 | 3 | 5 | SEM |
|---|---|---|---|---|
| Untreated control | 5.70^{a} | 6.75^{ab} | | 0.37 |
| 3% Verdad NV55 | 6.23^{ab} | 6.42^{ab} | 5.62^{a} | 0.23 |
| 3% Optiform SD4 | 7.01^{b} | 6.80^{b} | 6.46^{a} | 0.13 |
| 0.75% BCNV Liq | 6.42^{ab} | 6.09^{ab} | 5.98^{a} | 0.17 |
| 1% BCNV Liq | 5.98^{a} | 6.25^{ab} | 6.29^{a} | 0.20 |
| 0.75% WTI Dry | 6.45^{ab} | 6.36^{ab} | 6.23^{a} | 0.16 |
| 0.75% BCNV Dry | 6.52^{ab} | 5.93^{ab} | 6.33^{a} | 0.20 |
| 0.2% BactoCEASE | 5.62^{a} | 5.74^{a} | 5.91^{a} | 0.24 |
| 0.2% SHIELD NA | 5.86^{a} | 6.28^{ab} | 5.88^{a} | 0.17 |

^{a,b}Within each column, means with different superscripts are significantly different (p < 0.05)

### Discussion

This study demonstrated that vinegar based antimicrobials (BactoCEASE NV Liq and NV Dry) and propionic acid based antimicrobials (BactoCEASE and SHIELD NA) along with the competitor products i.e. Optiform SD4, Verdad NV 55 and WTI Dry controlled Salmonella Typhimurium and Escherichia coli O157:H7 for 5 weeks in enhanced pork loin containing approximately 70% moisture and pH 6.2. Untreated control showed >1 log increase in Salmonella Typhimurium and Escherichia coli O157:H7 counts at the end of 2 and 4 weeks respectively. APC results of the uninoculated pork chops showed that untreated control spoiled at the end of 3 weeks and the counts reached 7 log CFU/gm. All the antimicrobial treatments except 0.75% BCNV Liq, delayed the growth of aerobic bacteria for 5 weeks with final counts reaching to 5 log CFU/gm. 0.75% BCNV Liq treatment was not effective in controlling the APC's in one rep as counts reached 7 log CFU/gm at the end of 3 weeks whereas, in the other two reps, it was effective with the counts under 5 logs throughout 5 weeks; the cause for higher counts in one rep could not be determined. The pH of all the treatments typically remained stable throughout the testing period. It was observed that SHIELD NA treatment had a lower pH when compared with the remaining treatments and the reason could be due to its higher propionic acid content (57%) when compared to BactoCEASE (50%).

Instrumental L* values showed that BC, SHIELD NA and 0.75% BCNV Liq differed significantly with Optiform and Verdad. In contrast, there were no significant differences in a* and b* values among the treatments with few exceptions across testing intervals. A more appropriate method for measuring the color of pork chops is by keeping them under lighted display simulating the retail conditions and this was not adopted in this study due to limitation of storage space and resources. Purge loss results showed that BC, SHIELD NA and 0.75% BCNV Liq had higher purge loss when compared with Optiform and Verdad and the reason could be due to their low pH that could negatively impact the proteins and thereby impacting the water holding capacity. Overall cook loss results showed no significant differences between the treatments with the exception of 1% BCNV Liq which had higher cook loss at week-0 when compared to Optiform, Verdad and WTI Dry. BC had a higher cook loss when compared to Verdad at week-0. Overall sensory scores no significant differences among the treatments with the exception of BC and SHIELD NA which had lower initial sensory scores compared with Optiform treatment.

Overall, this study demonstrated that both vinegar and propionic acid based antimicrobials were effective in inhibiting the pathogen growth and extending the shelf life of enhanced pork loin. Competitor products were equally effective in their antimicrobial efficacy but it needs to be mentioned that the application levels of Optiform (3%) and Verdad (3%) were much higher than the vinegar (0.75% and 1%) and propionic acid (0.2%). Due to higher purge loss for BC and SHIELD NA treatments, further lower application levels have to be tested in future studies. Overall, no significant differences were observed among 1% BCNV Liq, BCNV Dry, WTI Dry, Optiform and Verdad treatments.

### Example 5

### Application to Ready-to-Eat Low-Sodium Uncured Turkey

Listeria monocytogenes (Lm) is a gram-positive, non-spore forming facultative anaerobe that poses a serious threat to consumer health and safety. Each year, Lm causes approximately 1,600 listeriosis cases and 260 deaths in the US and total annual costs of foodborne listeriosis were up to $1.1 billion. Among selected categories of Ready-to-Eat (RTE) foods, deli meats and frankfurters posed the greatest per serving risk of illness/death from Lm since they are often consumed directly from the refrigerator without reheating. Development of clean label ingredients (e.g. without chemical-sounding names, any ingredients that says artificial, ingredients that consumers cannot understand etc.) to inactivate Lm and to inhibit its growth in RTE meats represents a high priority for the meat industry. We have developed buffered vinegar based clean label antimicrobial systems i.e. BactoCEASE NV Dry (NV Dry) and Exp. BactoCEASE NVK Dry (NVK Dry; a low-sodium version) to protect RTE meat and poultry products from Lm and various foodborne pathogens. The previous Examples on enhanced pork loin, salami, cured turkey and RTE ham, demonstrated that vinegar based antimicrobials were effective in inhibiting Listeria monocytogenes, Salmonella spp and Escherichia coli O157:H7 without negatively impacting the sensory and quality characteristics of the meat products.

In the past few years, the US food industry has made many efforts to reduce the sodium content in processed foods. In 2008, the New York City Department of Health and Mental Hygiene started a voluntary ‘National Salt Reduction Initiative’ (NSRI) with the overall goal of reducing dietary salt consumption by 20% over five years. To help the public reach this goal, the NSRI challenged food manufacturers to reduce the salt content of packaged and prepared foods by 25% over the same period. They developed a database containing 62 packaged and 25 restaurant food categories that contributed to salt intake, and established targets for sodium content to be achieved by the end of 2012 and 2014. Lunch meats fell in one of the processed food categories that were targeted. Since March 2011, 28 major food manufacturers (e.g. Kraft, Unilever, Campbell soups) and leading restaurant chains (e.g. Subway, Starbucks) have agreed to pursue salt reduction targets in one or more food categories. Due to increased consumer demand for natural products, meat and poultry industry is currently looking for clean label antimicrobials for their low-sodium processed meats that can show good efficacy against Lm without contributing extra sodium. While sodium imparts flavor and texture to foods, it also plays a critical role in food safety by reducing water activity, thereby diminishing the growth of spoilage and pathogenic microorganisms. Hence, when developing low-sodium meats, precautions should be taken to avoid compromising on flavor, texture, and safety.

The current study highlights the efficacy of NV Dry and NVK Dry in controlling Lm in low-sodium deli-style uncured turkey. The objectives of this study were to validate the inhibition of Lm (two cocktails obtained from different sources) and spoilage microflora (lactic acid bacteria) on uncured deli-style turkey manufactured with different antimicrobial treatments, stored at 4° C. for up to 12 weeks, and to determine the effect of antimicrobial treatments on sensory and other quality attributes (color and purge).

### Materials and Methods

Production of Uncured Turkey Treatments.

Seven treatments were prepared, including an untreated control without any antimicrobial, 0.4%, 0.6% and 0.8% NV Dry (Lot no. 1401104161; acetic acid—67.2%, pH—6.06) and 0.5%, 0.7% and 0.9% NVK Dry (Lot no. 03032014; acetic acid—58%, pH—6.03). The application rates of the two antimicrobials were different as they were based on the acetic acid concentration. Turkey breasts were purchased from Turkey Valley Farms, Marshall, Minn. and kept in frozen conditions until use. The turkey breasts were thawed at 4° C. for 3 days before use. The turkey breasts were ground through a kidney plate (coarse grind) and 10% of the coarse ground product was taken out and ground through ⅛ inch plate (fine grind). For each treatment, 22.5 lb of coarse ground turkey and 2.5 lb of fine ground turkey was used so as to get better protein adhesion. The ground turkey was enhanced to 40% of original weight using 10 lb of brine solution (Table 39) containing water, salt, dextrose, sodium phosphate, potato starch, antimicrobial and tumbled under vacuum for 30 min (DVTS 50, Dupey Equipment Co. Clive, Iowa). After tumbling, the breasts were stuffed in plastic casings and cooked in a smoke house until the internal temperature reached 168° F. After cooking, the casings were peeled off and turkey logs were sliced (˜25 g each slice) and vacuum packaged in a high barrier vacuum pouches (B2175, Cryovac Food packaging and Food Solutions, Duncan S.C.). The desired concentration of salt in the final product was 1.4%. The dosage levels of antimicrobials were selected based on the previous challenge studies as mentioned earlier. The sliced product was transported to our lab under refrigerated conditions. The study was replicated thrice by manufacturing the treatments on three different days.

TABLE 39
Composition of brine solution used for turkey breast treatments

| | | | Dex- | Sodium | Potato | Anti- |
|---|---|---|---|---|---|---|
| | Water | Salt | trose | phosphate | Starch | microbial |
| Untreated | 8.22 | 0.49 | 0.49 | 0.10 | 0.70 | 0.00 |
| control | | | | | | |
| 0.4% NV Dry | 8.08 | 0.49 | 0.49 | 0.10 | 0.70 | 0.14 |
| 0.6% NV Dry | 8.01 | 0.49 | 0.49 | 0.10 | 0.70 | 0.21 |
| 0.8% NV Dry | 7.94 | 0.49 | 0.49 | 0.10 | 0.70 | 0.28 |
| 0.5% NVK Dry | 8.00 | 0.49 | 0.49 | 0.10 | 0.70 | 0.18 |
| 0.7% NVK Dry | 7.97 | 0.49 | 0.49 | 0.10 | 0.70 | 0.25 |
| 0.9% NVK Dry | 7.91 | 0.49 | 0.49 | 0.10 | 0.70 | 0.31 |

Cook Loss.

Cook loss was determined in second and third replications, by measuring the weight difference before and after cooking the product.

Preparation of Listeria Inocula.

Two cocktails of five strain mixture of Lm were used in this study and inoculated on different sets of turkey samples separately, thus resulting in two parallel challenge studies for each replication. The first cocktail consisted of LM 101 (hard salami isolate, serotype 4b), LM 108 (hard salami isolate, serotype 1/2a), LM 310 (goat milk cheese isolate, serotype 4), FSL-C1-109 (hotdog outbreak isolate) and V7 (raw milk isolate, serotype 1). These strains were provided by Dr. Kathy Glass (Assistant Director, Food Research Institute, University of Wisconsin, Madison, Wis.). The second cocktail consisted of H7762 (frankfurter isolate, serotype 4b), H7764 (deli turkey isolate, serotype 1/2a), H7769 (serotype 4b), H7976 and Scott A (clinical isolate, serotype 4b) and these strains were obtained from Dr. Jim Dickson (Professor, Dept. of Animal Science, Iowa State University (ISU) Ames, Iowa). One hundred micro liter of each strain from the stock culture cryovials (stored at −80° C.) containing 10% glycerol and was aseptically transferred to 10 ml tryptic soy broth (TSB) (Bacto, BD Biosciences, Sparks, Md.) and incubated at 37° C. for 18-20 h. A passage of the overnight culture was made by transferring 1000 into 10 ml of fresh TSB in an Erlenmeyer flask and incubated at 37° C. for 18-24 h. Cells were harvested by centrifugation (2500 rpm, 20 min) and suspended in 4.5 ml 0.1% buffered peptone water (pH 7.2). Equivalent populations of each isolate were combined to provide a five-strain mixture of Lm. Populations of each strain and the mixture were verified by plating on trypticase soy agar (BBL, BD Biosciences, Sparks, Md.) and modified Oxford agar (Listeria Selective Agar base, Difco, BD Biosciences, Sparks, Md.).

Listeria Inoculation and Testing.

Uncured turkey was surface inoculated with a five strain mixture of Lm to provide approximately 5-log CFU per 100-g package (equivalent to 3-log CFU per ml of rinse material when using 100 ml rinse for testing). For each package containing 4 slices, a total of 1.005 ml of liquid inoculum was added by distributing 0.335 ml over the surface of each slice excluding the top one, and slices were stacked such that the inoculum was between the slices. Inoculated products were vacuum packaged (C100 Multivac, Sepp Haggemuller KG, Wolfertschewenden, Germany) in gas-impermeable pouches (3 mil high barrier Nylon/EVOH/PE vacuum pouches, Prime Source, Kansas), and stored at 4° C. for up to 12 weeks. Triplicate inoculated samples for each treatment were assayed for changes in Lm populations, and duplicate uninoculated samples were assayed for changes in lactic acid bacteria and pH at 0, 2, 4, 6, 7, 8, 9, 10, 11 and 12 weeks. In addition, changes in odor, appearance, and turbidity in the package exudate were noted for all samples.

Lm populations were determined in rinse material obtained after adding 100 ml of sterile Butterfield phosphate buffer to the package and massaging the contents externally by hand for about two minutes. Serial (1:10) dilutions of rinse material were spread plated on duplicate plates of modified Oxford agar and incubated at 37° C. for 48 h. The acceptance criterion for an effective antimicrobial is it should not show >1 log increase in Lm counts throughout the testing period. For plotting the results, the Lm counts of each treatment over the period were averaged for three replications and then change from initial (time 0) Lm counts was determined.

pH, Lactic Acid Bacteria and Aerobic Plate Counts (APC).

Changes in pH and populations of competitive microflora were evaluated on uninoculated samples to determine the effect of the experimental treatments on the growth of spoilage microorganisms that may ultimately affect the growth of Lm. The pH (Inlab Expert Pro ISM probe; S220, Mettler Toledo Inc, Columbus, Ohio) was measured on the slurry obtained by removing a representative of 10 g of the uninoculated samples and homogenizing with 90 ml deionized water using a lab blender (Stomacher 400, A.J. Seward, London, England). For assaying lactic acid-producing bacteria and APC counts, the remaining portion of the uninoculated samples were rinsed with sterile Butterfield phosphate buffer (quantity equal to the weight of the turkey slices), and the serial dilutions of the rinse material was plated on All Purpose Tween agar (APT agar, Difco, Becton Dickinson, Sparks, Md.) with 0.002% bromocresol purple (25° C., 48-72 h) and Plate count agar (37° C., 48 h) respectively. APC counts were tested at 0, 4, 8 and 12 weeks.

Proximate and Active Ingredient Analysis.

Triplicate uninoculated samples of each treatment for each replication were analyzed in-house for moisture (AOAC International. 2000. Official methods of analysis, 17th ed.) (5 h, 100° C., vacuum oven method 950.46), water activity and pH. Duplicate samples of each treatment for each replication were analyzed for protein (Combustion-AOAC 990.03), fat (Fat in meat—AOAC 960.39), and sodium content (ICP-AOAC-965.17/985.01 mod.) by a commercial laboratory. Acetic acid was analyzed in-house for duplicate samples of each treatment at 0 week and 12 weeks and for each replication.

Instrumental Color Measurement.

Commission Internationale de l′Eclairage (CIE) L*, a*, b* values (lightness, redness, yellowness, respectively) were measured on each sample using a Hunterlab ColorFlex® Colorimeter (Hunter Associates Laboratory, Reston, Va.). Color was measured on duplicate uninoculated turkey samples for each treatment after removing the slices from the package at four different times post processing (0, 4, 8, and 12 weeks).

Purge Loss (Water Holding Capacity).

Purge loss was determined on duplicate samples of each treatment at four different times post processing (0, 4, 8 and 12 weeks) by a weight difference method. Each pre-packaged treatment sample was measured to determine gross weight. The samples were removed from the package, blotted dry with paper towels for 10 seconds, and a net sample weight was recorded. The package was dried with a paper towel and reweighed to determine net packaging weight. Differences were calculated to determine percent purge loss as shown below:

Purge loss (%)=[(Gross weight (with packaging)−packaging weight−sample weight)÷Gross weight]×100.

Sensory.

Informal sensory evaluation was conducted on the uninoculated antimicrobial treatments at 0, 4 and 8 weeks during each replication on a 9 point hedonic scale with 1 being “Dislike Extremely” and 9 being “Like Extremely”. Untreated control was tested only at week-0. Nine panelists were asked to cleanse their palate between samples with unsalted crackers and water.

Statistical Analysis.

The microbiological data was reported as average values and standard deviations (log CFU/ml rinse) for triplicate samples and three separate trials (n=3) for each test formulation. Differences between the experimental treatments and the untreated control were analyzed by multifactor analysis of variance (ANOVA) using the STATGRAPHICS® Centurion XV software package. Color, purge loss and sensory results were subjected to multifactor analysis of variance (ANOVA). All statistically significant differences in the study were reported at p<0.05 level.

### Results

Inhibition of Listeria monocytogenes (Univ of Wisconsin Strains).

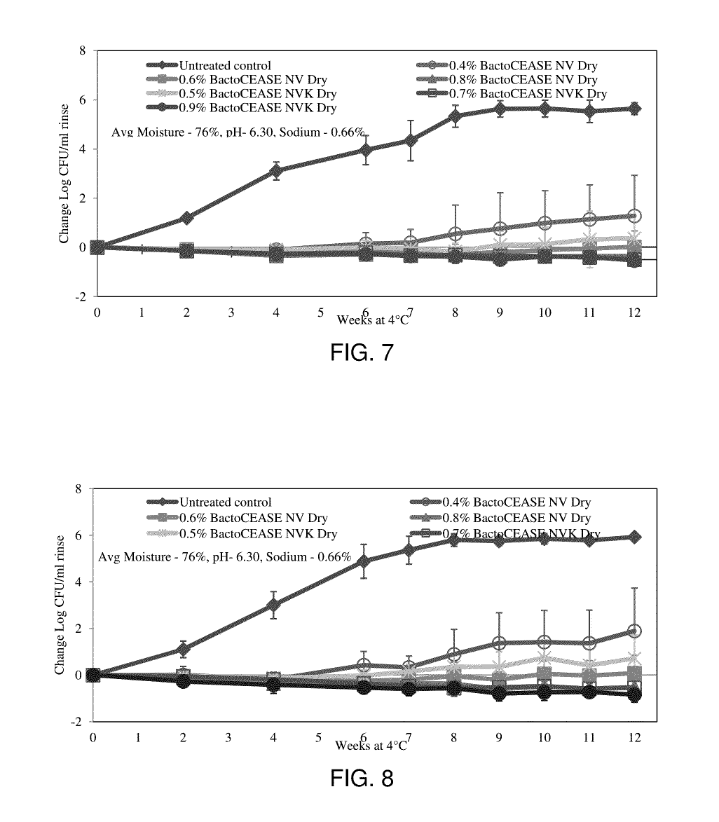

Results from three replications (FIG. 7) showed that at 4° C., 0.6% and 0.8% NV Dry; 0.7% and 0.9% NVK Dry significantly (p<0.05) inhibited the growth of Lm compared with the untreated control by showing <1 log increase for 12 weeks. The untreated control showed an average log increase of 1.19±0.12 and 3.11±0.37 log CFU/ml rinse by the end of 2 and 4 weeks respectively. 0.4% NV Dry showed an average increase of 0.55±1.17 log CFU/ml rinse at the end of 8 weeks. 0.5% NVK Dry showed an average increase of 0.33±1.14 log CFU/ml rinse at the end of 11 weeks.

Inhibition of Listeria monocytogenes (ISU Strains).

Results from three replications (FIG. 8) showed that at 4° C., 0.6% and 0.8% NV Dry; 0.7% and 0.9% NVK Dry significantly (p<0.05) inhibited the growth of Lm compared with the untreated control by showing <1 log increase for 12 weeks. The untreated control showed an average log increase of 1.11±0.36 and 3.00±0.58 log CFU/ml rinse by the end of 2 and 4 weeks. 0.4% NV Dry showed an average increase of 0.89±1.07 log CFU/ml rinse at the end of 8 weeks and 0.5% NVK Dry showed an average increase of 0.36±0.65 log CFU/ml rinse at the end of 9 weeks.

Lactic Acid Bacteria Counts and pH.

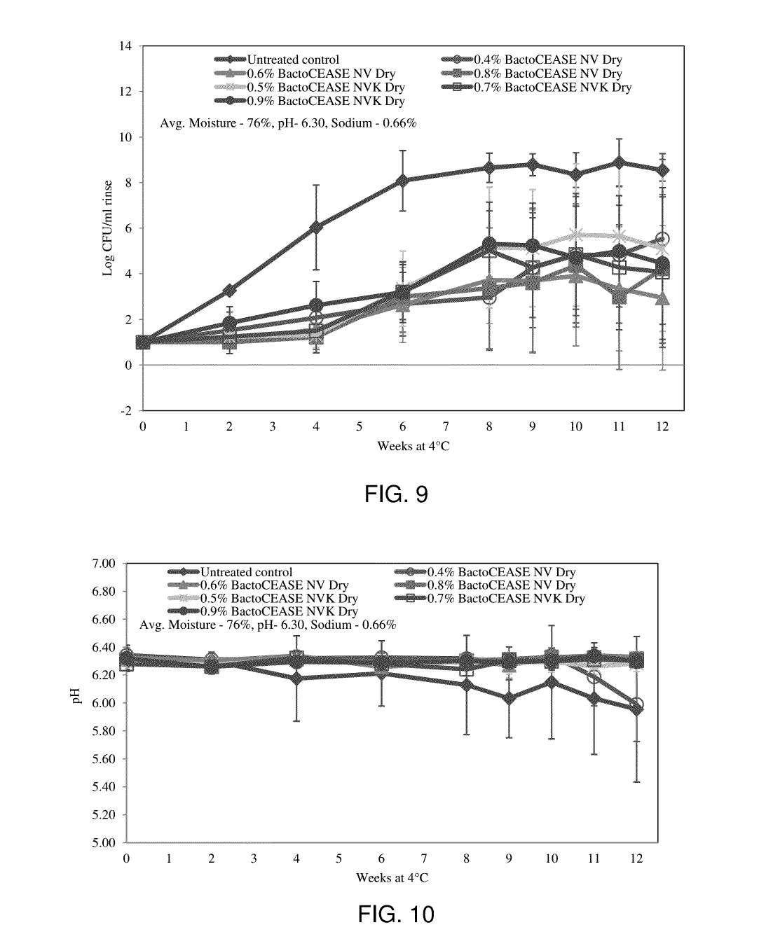

Lactic acid bacteria counts (FIG. 9) at 0-time for all the treatments were less than levels detectable by direct plating (<1 log CFU/ml rinse). At the end of 12 weeks, counts increased to 8.54±0.47 log CFU/ml rinse for untreated control. 0.4%, 0.6% and 0.8% NV Dry showed 5.53±3.75, 2.94±3.16 and 4.22±3.26 log CFU/ml rinse respectively. NVK Dry at 0.5%, 0.7% and 0.9% showed 5.10±3.62, 4.07±3.30 and 4.46±3.33 log CFU/ml rinse respectively. The pH results (FIG. 10) of the antimicrobial treatments remained stable throughout the testing period except 0.4% NV Dry which showed a drop of 0.2-0.3 units at the end of 11 and 12 weeks. Untreated control showed a drop in the pH throughout the testing period and by the end of 12 weeks, pH dropped to 0.5 units.

Aerobic Plate Counts.

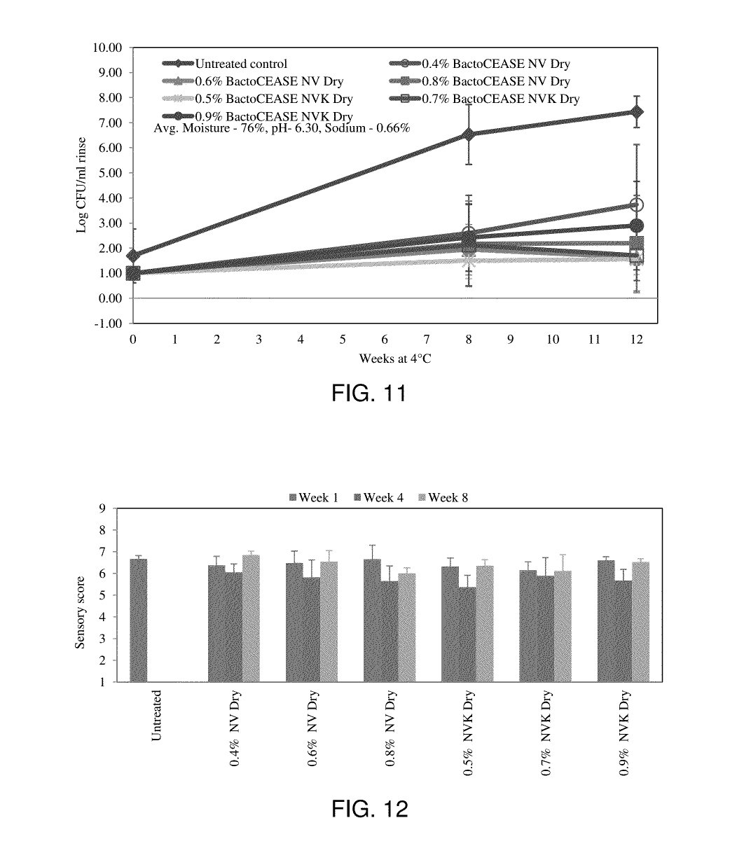

The initial APC counts (FIG. 11) for the untreated was 1.69±1.07 log CFU/ml rinse. By the end of 12 weeks, counts reached 7.43±0.63 log CFU/ml rinse. Initial counts for the antimicrobial treatments were <1 log CFU/ml rinse. By the end of 12 weeks, NV Dry at 0.4%, 0.6% and 0.8% showed 3.73±2.40, 1.63±1.41, and 2.20±1.91 log CFU/ml rinse respectively. NVK Dry at 0.5%, 0.7% and 0.9% showed 1.56±0.61, 1.70±1.00, and 2.90±1.76 log CFU/ml rinse respectively.

Proximate and Active Ingredient Results.

Average proximate values of the treatments are shown in Tables 40 and 41. pH values of the treatments ranged from 6.27±0.04 to 6.34±0.06. Moisture results ranged from 75.23±0.96 to 75.93±0.84%. Water activity of the treatments ranged from 0.9796±0.0027 to 0.9840±0.0043. Fat and protein content ranged from 0.50±0.07 to 0.62±0.12% and 17.48±0.74 to 18.33±0.85% respectively. Sodium and potassium content were in the range of 0.62±0.06 to 0.83±0.04 and 0.25±0.01 to 0.54±0.02. The acetic acid results of the antimicrobial treatments were in the expected range (Table 42).

TABLE 40
Proximate results of uncured turkey treatments¹

| Treatment | pH | Moisture (%) | Water activity | Protein (%) | Fat (%) |
|---|---|---|---|---|---|
| Untreated control | 6.32 ± 0.05 | 75.58 ± 1.43 | 0.9840 ± 0.0043 | 18.33 ± 0.85 | 0.59 ± 0.09 |
| 0.4% NV Dry | 6.34 ± 0.06 | 75.82 ± 0.86 | 0.9838 ± 0.0021 | 18.02 ± 0.59 | 0.57 ± 0.22 |
| 0.6% NV Dry | 6.33 ± 0.06 | 75.25 ± 1.58 | 0.9829 ± 0.0018 | 18.27 ± 0.48 | 0.62 ± 0.12 |
| 0.8% NV Dry | 6.31 ± 0.07 | 75.23 ± 0.96 | 0.9796 ± 0.0027 | 17.48 ± 0.74 | 0.56 ± 0.20 |
| 0.5% NVK Dry | 6.30 ± 0.05 | 75.93 ± 0.49 | 0.9810 ± 0.0025 | 18.07 ± 1.35 | 0.56 ± 0.15 |
| 0.7% NVK Dry | 6.27 ± 0.04 | 75.29 ± 1.32 | 0.9811 ± 0.0038 | 17.87 ± 1.02 | 0.59 ± 0.10 |
| 0.9% NVK Dry | 6.32 ± 0.08 | 75.72 ± 1.45 | 0.9799 ± 0.0018 | 17.90 ± 0.94 | 0.50 ± 0.07 |

¹Results are an average ± standard deviation of triplicate (pH, moisture and water activity) and duplicate (protein and fat) samples for three replications.

TABLE 41
Sodium and potassium results of uncured turkey treatments¹

| Treatment | Sodium (%) | Potassium (%) |
|---|---|---|
| Untreated control | 0.66 ± 0.04 | 0.25 ± 0.01 |
| 0.4% NV Dry | 0.74 ± 0.04 | 0.25 ± 0.01 |
| 0.6% NV Dry | 0.77 ± 0.03 | 0.25 ± 0.01 |
| 0.8% NV Dry | 0.83 ± 0.04 | 0.25 ± 0.01 |
| 0.5% NVK Dry | 0.62 ± 0.06 | 0.42 ± 0.01 |
| 0.7% NVK Dry | 0.63 ± 0.04 | 0.50 ± 0.02 |
| 0.9% NVK Dry | 0.63 ± 0.03 | 0.54 ± 0.02 |

¹Results are an average ± standard deviation of duplicate samples for three replications.

TABLE 42
Acetic acid results of uncured turkey treatments¹

| Treatment | Target (%) | Acetic acid (%) |
|---|---|---|
| Untreated control | <0.1 | 0.0266 ± 0.0120 |
| 0.4% NV Dry | 0.2688 | 0.2959 ± 0.0150 |
| 0.6% NV Dry | 0.4032 | 0.4308 ± 0.0349 |
| 0.8% NV Dry | 0.5376 | 0.5792 ± 0.0314 |
| 0.5% NVK Dry | 0.2900 | 0.3543 ± 0.0354 |
| 0.7% NVK Dry | 0.4060 | 0.4971 ± 0.0330 |
| 0.9% NVK Dry | 0.5220 | 0.5247 ± 0.0564 |

¹Results are an average ± standard deviation of duplicate samples for three replications.

Instrumental Color.

Instrumental color measurement results are shown in Tables 43-45. Statistical analysis of L* values showed no significant differences between the treatments.

TABLE 43
Instrumental color (L* values) of uncured turkey treatments

| | Weeks (W) | | | | |
|---|---|---|---|---|---|
| Treatment | 0 | 4 | 8 | 12 | SEM |
| Untreated control | 78.17 | 77.28 | 77.08 | 78.07 | 0.15 |
| 0.4% NV Dry | 78.68 | 77.57 | 77.65 | 78.33 | 0.17 |
| 0.6% NV Dry | 77.78 | 78.11 | 77.40 | 78.23 | 0.17 |
| 0.8% NV Dry | 78.12 | 76.80 | 76.81 | 77.69 | 0.19 |
| 0.5% NVK Dry | 78.38 | 77.51 | 77.63 | 78.27 | 0.15 |
| 0.7% NVK Dry | 78.40 | 77.69 | 78.10 | 78.57 | 0.15 |
| 0.9% NVK Dry | 78.40 | 77.37 | 77.09 | 78.22 | 0.13 |

TABLE 44
Instrumental color (a* values) of uncured turkey treatments

| | Weeks (W) | | | | |
|---|---|---|---|---|---|
| Treatment | 0 | 4 | 8 | 12 | SEM |
| Untreated control | 1.79 | 2.11 | 2.16 | 1.90 | 0.10 |
| 0.4% NV Dry | 1.67 | 2.12 | 2.28 | 2.11 | 0.11 |
| 0.6% NV Dry | 2.06 | 2.26 | 2.07 | 2.07 | 0.08 |
| 0.8% NV Dry | 2.36 | 2.83 | 2.39 | 2.12 | 0.09 |
| 0.5% NVK Dry | 1.96 | 2.14 | 1.65 | 2.14 | 0.10 |
| 0.7% NVK Dry | 1.72 | 1.90 | 1.88 | 2.02 | 0.09 |
| 0.9% NVK Dry | 1.70 | 1.86 | 2.10 | 1.57 | 0.08 |

TABLE 45
Instrumental color (b* values) of uncured turkey treatments

| | Weeks (W) | | | | |
|---|---|---|---|---|---|
| Treatment | 0 | 4 | 8 | 12 | SEM |
| Untreated control | 13.24 | 13.73 | 13.08 | 11.93 | 0.15 |
| 0.4% NV Dry | 13.63 | 13.46 | 13.78 | 14.60 | 0.17 |
| 0.6% NV Dry | 13.11 | 13.09 | 13.47 | 13.79 | 0.17 |
| 0.8% NV Dry | 12.83 | 13.40 | 12.40 | 13.95 | 0.19 |
| 0.5% NVK Dry | 13.97 | 13.74 | 13.43 | 14.35 | 0.15 |
| 0.7% NVK Dry | 13.67 | 13.28 | 13.52 | 14.51 | 0.15 |
| 0.9% NVK Dry | 13.49 | 12.97 | 13.40 | 14.43 | 0.13 |

Purge Loss.

Purge loss values are shown in Table 46. Statistical analysis of purge loss values showed no significant differences between the three dosages of NV Dry and three dosages of NVK Dry treatments. No significant differences were seen between untreated, 0.4% and 0.8% NV Dry treatments whereas significant (p<0.05) differences were seen between untreated and the remaining antimicrobial treatments at 0 and 8 weeks. 0.9% NVK Dry differed significantly (p<0.05) by having higher purge when compared to 0.4% and 0.6% NV Dry and untreated control at week-8.

TABLE 46
Purge loss (%) of uncured turkey treatments

| | Weeks (W) | | | | |
|---|---|---|---|---|---|
| Treatment | 0 | 4 | 8 | 12 | SEM |
| Untreated control | 1.41^{a} | 2.39^{a} | 3.13^{a} | 5.08^{a} | 0.39 |
| 0.4% NV Dry | 2.35^{ab} | 3.52^{a} | 4.70^{ab} | 3.40^{a} | 0.31 |
| 0.6% NV Dry | 2.71^{ab} | 4.76^{a} | 4.31^{ab} | 4.35^{a} | 0.25 |
| 0.8% NV Dry | 3.00^{ab} | 2.99^{a} | 4.22^{b} | 4.47^{a} | 0.26 |
| 0.5% NVK Dry | 2.78^{ab} | 4.89^{a} | 5.42^{b} | 4.78^{a} | 0.33 |
| 0.7% NVK Dry | 3.77^{ab} | 5.19^{a} | 4.87^{b} | 4.89^{a} | 0.27 |
| 0.9% NVK Dry | 4.38^{b} | 5.27^{a} | 5.00^{b} | 4.28^{a} | 0.31 |

^{a,b}Within each column, means with different superscripts are significantly different (p < 0.05)

Cook Loss.

Statistical analysis of cook loss values (Table 47) showed no significant differences between the treatments.

TABLE 47
Cook loss (%) of uncured turkey treatments

| Treatment | Cook loss (%) |
|---|---|
| Untreated control | 2.62 ± 2.01 |
| 0.4% NV Dry | 1.87 ± 0.10 |
| 0.6% NV Dry | 2.12 ± 0.97 |
| 0.8% NV Dry | 1.27 ± 0.04 |
| 0.5% NVK Dry | 1.74 ± 0.39 |
| 0.7% NVK Dry | 1.87 ± 0.20 |
| 0.9% NVK Dry | 1.53 ± 0.46 |

Sensory.

No significant differences were observed in the sensory scores (FIG. 12) between the treatments.

### Discussion

This study demonstrated that NV Dry at 0.6% and 0.8%; NVK Dry at 0.7% and 0.9% controlled Lm for 12 weeks in low-sodium RTE uncured turkey containing approximately 76% moisture pH 6.30 and 0.66% sodium. Untreated control showed >1 log increase in Lm counts at the end of 2 weeks in all the three replications. Both the antimicrobials showed similar Lm inhibition against the two cocktails tested in the study. The pH values typically remained stable for the antimicrobial treatments throughout the test period thus confirming that inhibition of Lm was likely due to the antimicrobial treatment itself, rather than interference with competitive microflora. There were no significant differences in the measured L*, a* and b* values between the treatments. Purge loss results showed no significant differences between the three dosages of each antimicrobial. However, 0.9% NVK Dry showed higher purge loss when compared to untreated, 0.4% and 0.6% NV Dry. Purge loss could be minimized by adding a variety of binding agents available in the market. Sensory results showed no significant differences between the treatments at 0, 4 and 8 weeks thus showing that NV Dry and NVK Dry had no adverse taste impact on the treated uncured turkey. Lm inhibition results showed both NV Dry and NVK Dry had similar antimicrobial efficacy since the active ingredient in both is acetic acid. It is noteworthy to mention that NVK Dry did not contribute any extra sodium in the final product when compared to untreated control because it contained potassium hydroxide as a buffering agent. NV Dry contributed 0.1-0.2% extra sodium in the final product because it contained sodium hydroxide as a buffering agent.

Overall, this study demonstrated that clean label ingredients like NV Dry and NVK Dry were effective in inhibiting Lm (by showing <1 log increase for 12 weeks) in low-sodium uncured deli-style turkey without impacting the product quality and sensory characteristics.

We claim:

1. A method of preparing a vinegar-based antimicrobial for meat products, the steps of:
(a) partially neutralizing vinegar by the addition of a mild acid;
(b) removing the water from the partially neutralized vinegar; and
(c) spraying vinegar to the dried, partially neutralized vinegar.

2. A method of protecting meat against contamination by food pathogens, comprising the step of applying an efficacious amount of the antimicrobial of claim 1.
